(19) United States
(12) Patent Application Publication
(10) Pub. No.: US 2023/0367053 A1
(43) Pub. Date: Nov. 16, 2023

(54) POLARIZATION IMAGING DEVICE, BINARY MASK, IMAGE PROCESSING SYSTEM, AND IMAGE PROCESSING METHOD

(71) Applicant: SONY GROUP CORPORATION, TOKYO (JP)

(72) Inventor: ILYA RESHETOUSKI, TOKYO (JP)

(21) Appl. No.: 18/248,462

(22) PCT Filed: Sep. 27, 2021
(86) PCT No.: PCT/JP2021/035247

§ 371 Date: Apr. 10, 2023

(30) Foreign Application Priority Data
Oct. 16, 2020 (JP) 2020-174716

(51) Int. Cl. G02B 5/30; G02B 5/20; H04N 25/443; H04N 23/12; H04N 25/11; H04N 23/76

(52) U.S. Cl. CPC G02B 5/3025; G02B 5/201; H04N 25/443; H04N 23/12; H04N 25/11; H04N 23/76

(57) ABSTRACT

Provided is a polarization imaging device (100) that can be downsized while suppressing deterioration in image quality. A polarization imaging device (100) includes an image sensor (50) having a first sub-sensor region, a second sub-sensor region, a third sub-sensor region, and a fourth sub-sensor region that are evenly divided and are adjacent to each other, and a binary mask (10) evenly superimposed on the first sub-sensor region, the second sub-sensor region, the third sub-sensor region, and the fourth sub-sensor region, the binary mask including a first sub-mask region having a first polarization direction, a second sub-mask region having a second polarization direction, a third sub-mask region having a third polarization direction, and a fourth sub-mask region having a fourth polarization direction, wherein each of the first sub-mask region, the second sub-mask region, the third sub-mask region, and the fourth sub-mask region is disposed so as to be evenly superimposed on the first sub-sensor region, the second sub-sensor region, the third sub-sensor region, and the fourth sub-sensor region.

### FIELD

The present disclosure relates to a polarization imaging device, a binary mask, an image processing system, and an image processing method.

BACKGROUND

In general, a lensless camera (polarization imaging device) can obtain a captured image by disposing a mask (optical element) configured by disposing a light transmitting filter and a light non-transmitting filter in a two-dimensional pattern in front of an image sensor and reconstructing a scene from observation data of the image sensor. For example, in a lensless camera, information about how light is projected on an image sensor via the mask is defined in advance as a matrix, and a captured image of an actual scene is reconstructed using the matrix and observation data of the image sensor. Since such a lensless camera does not use an optical lens or the like, it is possible to realize downsizing, weight reduction, cost reduction, and the like of the polarization imaging device.

In recent years, it is known that an imaging technique based on polarization can be applied to various fields. Examples thereof include a medical field and a detection technology field. In addition, it is known that various imaging methods are included in the polarization-based imaging technology.

### CITATION LIST

### Patent Literature

Patent Literature 1: WO 2007/121475 A

Patent Literature 2: US 2011/0228895 A

Patent Literature 3: US 2017/0351012 A

Patent Literature 4: U.S. Pat. No. 4,209,780

### Non Patent Literature

Non Patent Literature 1: Four-directional pixel-wise polarization CMOS image sensor using air-gap wire grid on 2.5-μm back-illuminated pixels, T. Yamazaki et al., 2016 IEEE International Electron Devices Meeting (IEDM), San Francisco, CA, 2016, pp. 8.7.1-8.7.4.

Non Patent Literature 2: Polarization camera for computer vision with a beam splitter, Lawrence B. Wolff, J. Opt. Soc. Am. A 11, 2935-2945 (1994)

Non Patent Literature 3: Matrix Fourier optics enables a compact full-Stokes polarization camera, Noah A. Rubin, Gabriele D′ Aversa, Paul Chevalier, Zhujun Shi, Wei Ting Chen, Federico Capasso, Science05 July 2019

Non Patent Literature 4: Coded aperture imaging with uniformly redundant arrays, Fenimore, E. E., Cannon, T. M., Applied Optics 17(3), 337 (February 1978)

### SUMMARY

### Technical Problem

However, in the related art techniques in Patent Literatures 1 and 2 and the like, a lens-based optical system is required, and an increase in size of the polarization imaging device is required. In addition, in the related art techniques in Patent Literatures 3 and 4, there is a possibility that the image quality at the time of reconstruction is deteriorated.

Therefore, the present disclosure proposes a polarization imaging device, a binary mask, an image processing system, and an image processing method that are novel and improved, and can be downsized while suppressing deterioration in image quality.

### Solution to Problem

According to the present disclosure, a polarization imaging device is provided that includes: an image sensor having a first sub-sensor region, a second sub-sensor region, a third sub-sensor region, and a fourth sub-sensor region that are evenly divided and are adjacent to each other; and a binary mask evenly superimposed on the first sub-sensor region, the second sub-sensor region, the third sub-sensor region, and the fourth sub-sensor region, the binary mask including a first sub-mask region having a first polarization direction, a second sub-mask region having a second polarization direction, a third sub-mask region having a third polarization direction, and a fourth sub-mask region having a fourth polarization direction, wherein each of the first sub-mask region, the second sub-mask region, the third sub-mask region, and the fourth sub-mask region is disposed so as to be evenly superimposed on the first sub-sensor region, the second sub-sensor region, the third sub-sensor region, and the fourth sub-sensor region.

Moreover, according to the present disclosure, a polarization imaging device is provided that includes: an image sensor having a plurality of sub-sensor regions disposed in a distributed manner block by block; and a binary mask that is superimposed on the plurality of sub-sensor regions and has a plurality of sub-mask regions having different polarization directions for the each block, wherein each of the plurality of sub-mask regions is disposed to correspond to the plurality of sub-sensor regions.

### BRIEF DESCRIPTION OF DRAWINGS

FIG. 1 is an explanatory diagram for explaining an example of a configuration of a polarization imaging device 100 according to an embodiment of the present disclosure.

FIG. 2 is an explanatory diagram for explaining a URA mask 10U according to an embodiment of the present disclosure.

FIG. 3 is an explanatory diagram for describing a method of generating a URA pattern according to an embodiment of the present disclosure.

FIG. 4 is a diagram illustrating a configuration example of an image processing system 1 according to an embodiment of the present disclosure.

FIG. 5 is an explanatory diagram for explaining an embodiment of the present disclosure.

FIG. 6A is an explanatory diagram (part 1) for explaining the URA mask 10U according to the first example of an embodiment of the present disclosure.

FIG. 6B is an explanatory view for explaining a mask pattern according to the first example of an embodiment of the present disclosure.

FIG. 7A is an explanatory diagram for explaining a basic pattern 16 according to the first example of an embodiment of the present disclosure.

FIG. 7B is an explanatory diagram (part 2) for explaining the URA mask 10U according to the first example of an embodiment of the present disclosure.

FIG. 8 is an explanatory diagram (part 3) for explaining the URA mask 10U according to the first example of an embodiment of the present disclosure.

FIG. 9 is an explanatory diagram (part 4) for explaining the URA mask 10U according to the first example of an embodiment of the present disclosure.

FIG. 10 is an explanatory diagram (part 1) for explaining the URA mask 10U according to the second example of an embodiment of the present disclosure.

FIG. 11 is an explanatory diagram (part 2) for explaining the URA mask 10U according to the second example of an embodiment of the present disclosure.

FIG. 12 is an explanatory diagram (part 1) for explaining the URA mask 10U according to the third example of an embodiment of the present disclosure.

FIG. 13A is an explanatory diagram (part 2) for explaining the URA mask 10U according to the third example of an embodiment of the present disclosure.

FIG. 13B is an explanatory diagram for explaining the basic pattern 16 according to the third example of an embodiment of the present disclosure.

FIG. 14 is an explanatory diagram for explaining the URA mask 10U according to the first modification of an embodiment of the present disclosure.

FIG. 15 is an explanatory diagram (part 1) for explaining the URA mask 10U according to the second modification of an embodiment of the present disclosure.

FIG. 16A is an explanatory diagram (part 2) for explaining the URA mask 10U according to the second modification of an embodiment of the present disclosure.

FIG. 16B is an explanatory view for explaining a mask pattern according to the second modification of an embodiment of the present disclosure.

FIG. 17 is an explanatory diagram (part 3) for explaining the URA mask 10U according to the second modification of an embodiment of the present disclosure.

FIG. 18 is a block diagram illustrating an example of a function configuration of an image processing device according to an embodiment of the present disclosure.

FIG. 19 is a flowchart of an image processing method according to an embodiment of the present disclosure.

FIG. 20 is a hardware configuration diagram illustrating an example of a computer 1000 that implements functions of an image processing device 200 according to an embodiment of the present disclosure.

FIG. 21 is a diagram illustrating an example of a schematic configuration of an endoscopic surgery system.

FIG. 22 is a block diagram illustrating an example of function configurations of a camera head and a CCU.

FIG. 23 is a block diagram illustrating an example of a schematic configuration of a vehicle control system.

FIG. 24 is an explanatory diagram illustrating an example of installation positions of an outside-vehicle information detector and an imaging unit.

### DESCRIPTION OF EMBODIMENTS

Hereinafter, preferred embodiments of the present disclosure will be described in detail with reference to the accompanying drawings. Note that, in the present specification and the drawings, components having substantially the same function configuration are denoted by the same reference numerals, and redundant description is omitted. Furthermore, in the present specification and the drawings, similar components of different embodiments may be distinguished by adding different alphabets after the same reference numerals. However, in a case where it is not necessary to particularly distinguish similar components, only the same reference numeral is assigned.

Note that the embodiments of the present disclosure are not limited to being applied to the above-described lensless camera, and may be applied to other imaging systems and the like. Furthermore, in the following description, the substantially constant side lobe means not only a mathematically constant but also a case where there is an allowable difference in the reconstruction of the captured image to be described later (for example, from the viewpoint of the image quality of the captured image obtained by the reconstruction or the like).

Note that the description will be given in the following order.
1. An embodiment of the present disclosure
   1.1. Introduction
   1.2. Outline and principle of lensless camera (polarization imaging device)
   1.3. Configuration of image processing system
2. Function of image processing system
   2.1. Overview
   2.2. Image processing device
   2.3. Image processing method
   2.4. Summary
3. Hardware configuration example
4. Application example to endoscopic surgery system
5. Application example to mobile body
6. Supplement

### 1. An Embodiment of the Present Disclosure

### 1.1. Introduction

As described above, in recent years, it is known that the polarization-based imaging technology can be applied to various fields such as a medical field and a detection technology, and it is known that the polarization-based imaging technology includes various imaging methods. As a specific example, a method of performing detection using different sensor portions of an image sensor or a plurality of image sensors based on a spectrum of incident light is known (Non Patent Literatures 2 to 3). However, these methods are likely to result in a large form-factor (LFF), and thus there is room for further improvement.

Furthermore, as another example, a method of setting an array of polarization filters in a focal surface of an image sensor is known (Patent Literature 1, Non Patent Literature 1). In this case, for example, the array is set in the development stage of the image sensor or the like. However, in this case, since the image sensor may require an optical system, there is room for further improvement.

Furthermore, as another example, an imaging technique using a lensless camera is known (Patent Literatures 2-3). However, in this case, although the system can be reduced, a large amount of data processing may be required, and thus there is room for further improvement.

Furthermore, as another example, an imaging technique using a random mask is known (Patent Literatures 3). However, in this case, the random mask can be applied to encryption, for example, but the quality of imaging may be deteriorated, and thus there is room for further improvement.

As described above, in the related art techniques, a lens-based optical system is required, and an increase in size of the polarization imaging device is required. In addition, in the related art techniques, there is a possibility that the image quality at the time of reconstruction is deteriorated. For this reason, in the related art techniques, it may be difficult to achieve downsizing while suppressing deterioration in image quality. Therefore, in the following embodiments, a polarization imaging device, a binary mask, an image processing system, and an image processing method that are novel and improved, and can be downsized while suppressing deterioration in image quality will be described with examples.

### 1.2. Outline and Principle of Lensless Camera (Polarization Imaging Device)

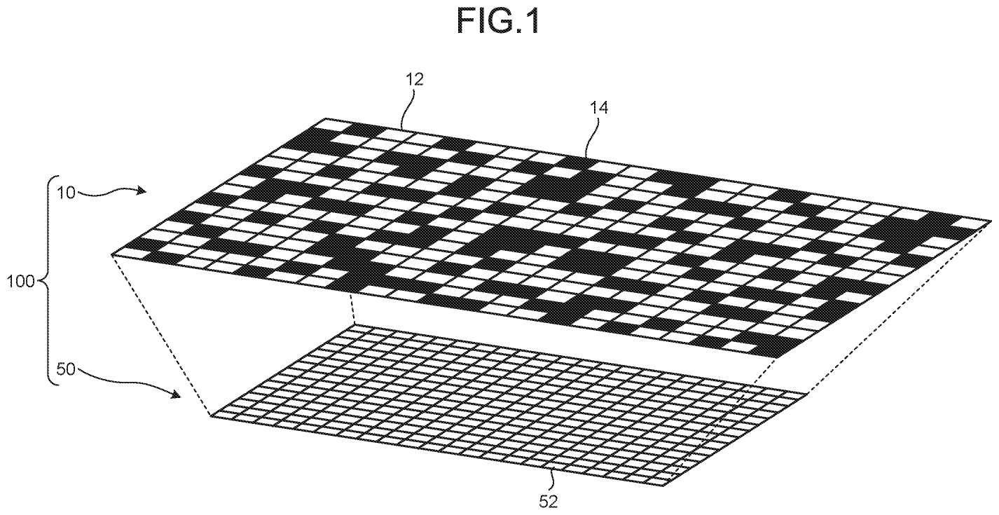

First, before describing details of the embodiment of the present disclosure, an outline and a principle of a lensless camera (polarization imaging device) will be described with reference to FIG. 1. FIG. 1 is an explanatory diagram for explaining an example of a configuration of a polarization imaging device 100 according to the present embodiment. As illustrated in FIG. 1, the polarization imaging device (lensless camera) 100 includes a binary mask 10 and an image sensor 50. The binary mask 10 is, for example, a mask having a predetermined pattern including a plurality of light transmitting filters 12 (an example of a light transmitting material) and a plurality of light non-transmitting filters 14 (an example of a light non-transmitting material) disposed in a two-dimensional lattice shape. For example, the binary mask 10 is a uniformly redundant arrays (URA) mask or a modified uniformly redundant arrays (MURA) mask. Furthermore, the image sensor 50 includes a plurality of pixels 52 disposed in a two-dimensional lattice shape or in one column (or one row) on the light receiving face. Then, each pixel 52 receives light from each point of the scene to be imaged, thereby generating an electronic signal (observation data). Furthermore, in the lensless camera, the polarization captured image of the actual scene can be obtained by projecting the electronic signal to a position on the plane corresponding to the position of the corresponding pixel 52. At this time, light from each point of the scene passes through the light transmitting filter 12 of the binary mask 10 and is received by each pixel 52 of the image sensor 50.

As illustrated in FIG. 1, the binary mask 10 according to the present embodiment is used by being superimposed on an image sensor (line sensor or area sensor) 50. In other words, the image sensor 50 is provided under the plane of the binary mask 10. That is, as illustrated in FIG. 1, the polarization imaging device 100 according to the present embodiment includes the image sensor 50 having one or more scanning lines (rows) (specifically, one scanning line includes a plurality of pixels disposed along the row direction.), and the binary mask 10 superimposed on the image sensor 50. Furthermore, as illustrated in FIG. 1, the binary mask 10 includes a plurality of unit elements having substantially the same size as the pixel 52 included in the image sensor 50, and each of the unit elements includes a light transmitting filter 12 and a light non-transmitting filter 14. More specifically, the binary mask 10 has a predetermined pattern including a plurality of light transmitting filters 12 and a plurality of light non-transmitting filters 14 disposed in a two-dimensional lattice shape. In other words, it can be said that the binary mask 10 is a type of optical element.

Furthermore, the autocorrelation function of a predetermined pattern repeated on the binary mask 10 has a sharp peak and has a very small side lobe with respect to the peak. By using such a binary mask 10, a captured image of an actual scene can be reconstructed from observation data (signal) acquired by the image sensor 50.

Not all binary masks 10 are suitable for reconstruction of the captured image. Here, in the URA mask 10U whose predetermined pattern is the URA pattern, the predetermined pattern including a plurality of basic patterns repeated while being periodically displaced in the optical element has a constant or substantially constant side lobe. As described above, since the URA mask 10U has a side lobe having constant or substantially constant properties, it is known that the URA mask is suitable for reconstruction of a captured image.

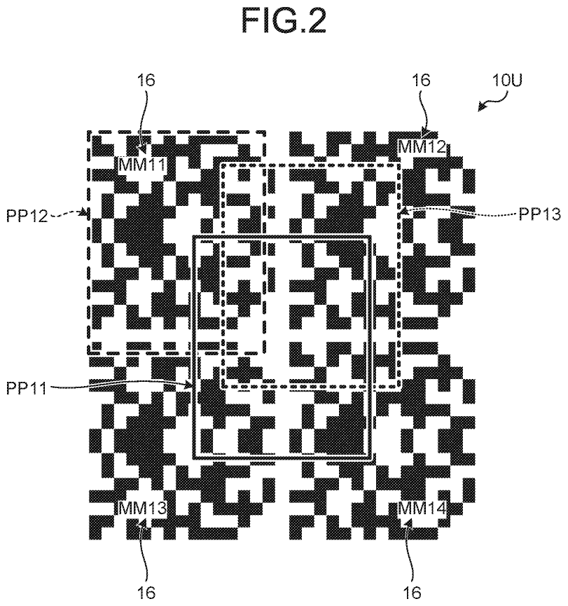

FIG. 2 is an explanatory diagram for describing a URA mask 10U according to the present embodiment. FIG. 2 illustrates mosaic of four blocks (configured by mosaic MM11 to mosaic MM14), defined by 2×2, configured by a predetermined pattern. Hereinafter, this mosaic is appropriately referred to as a basic pattern 16. In addition, the size of the predetermined pattern in two-dimension unit is expressed by M×N when defined by the number of unit elements. FIG. 2 illustrates a URA mask 10U with 29×33 pixels. Note that a solid line (frame PP11) indicates that the size of the image sensor 50 is 15×17 pixels. Therefore, the size of the URA mask 10U is about twice the size of the image sensor 50. In addition, dotted lines (frame PP12 and frame PP13) indicate patterns in a lattice shape for taking in different polarized light. Here, the range of pixels indicated by the solid line is the range of light used for reconstruction of the captured image. Although not illustrated, it is assumed that a plurality (2×2) of basic patterns 16 is disposed outward.

Then, the polarization imaging device 100 according to the present disclosure sets (arranges) a light control material for selectively controlling incident light in the light transmitting filter 12, thereby reconstructing the captured image. For example, the polarization imaging device 100 sets the polarization filter to reconstruct the captured image. Hereinafter, the outline and principle of the present disclosure will be described.

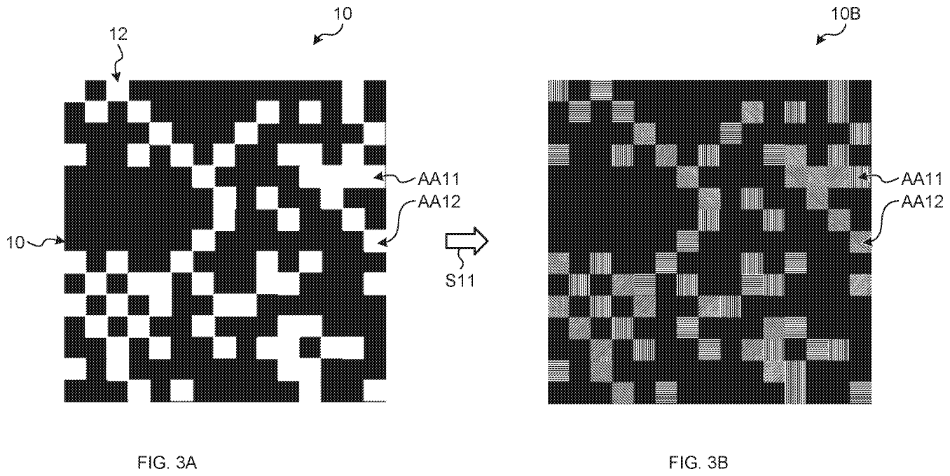

Next, the setting of the polarization filter will be described with reference to FIG. 3. FIG. 3 is an explanatory diagram for describing a method of generating a URA pattern according to the present embodiment. In FIG. 3, a polarization filter is set to the light transmitting filter 12 constituting the binary mask 10 (step S11). (A) of FIG. 3 is a diagram before setting, and (B) of FIG. 3 is a diagram after setting. The mask 10 after the setting of the polarization filter is referred to as a mask 10B. In (B) of FIG. 3, different polarization filters are set for respective areas (blocks). In (B) of FIG. 3, lines in any of four directions (vertical, horizontal, oblique×2) are drawn in the area of the light transmitting filter 12 for which the polarization filter is set. These four directions indicate that polarization directions are different. Here, the vertical direction is defined as 90 degrees, the horizontal direction is defined as 0 degrees, and the oblique directions are defined as 45 degrees and 135 degrees. In FIG. 3, a polarization filter that transmits light in the longitudinal direction is set for the light transmitting filter of an area AA11. For example, a polarization filter that transmits light in an oblique direction is set for the light transmitting filter of an area AA12. As a result, each area has a different polarization direction. As a result, the captured image can be reconstructed by a lensless camera. However, with the setting of the polarization filter, the side lobes may not be constant or substantially constant, and thus the quality of the reconstruction of the captured image may deteriorate. Note that the polarization direction according to the embodiment is not limited to the example illustrated in FIG. 3. For example, three or more polarization directions may be used to reconstruct the captured image.

Hereinafter, details of the polarization imaging device 100 according to the embodiment of the present disclosure created by the present inventors will be described. The polarization imaging device 100 according to the embodiment of the present disclosure enables a lensless reconstruction of a captured image and enables a constant or substantially constant side lobe. Therefore, it is possible to reconstruct a captured image with high quality and high memory efficiency.

Therefore, the present disclosure proposes a polarization imaging device, a binary mask, an image processing system, and an image processing method that are novel and improved, and can be downsized while suppressing deterioration in image quality.

### 1.3. Configuration of Image Processing System

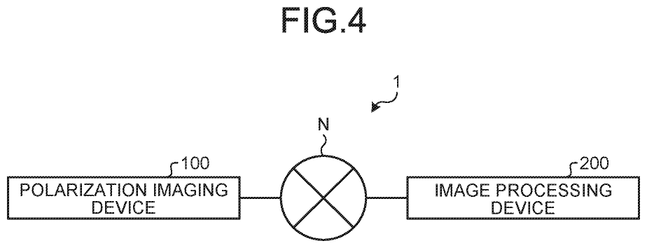

A configuration of an image processing system 1 according to the embodiment will be described. FIG. 4 is a diagram illustrating a configuration example of the image processing system 1. As illustrated in FIG. 4, the image processing system 1 includes the polarization imaging device 100 and an image processing device 200. Various devices can be connected to the polarization imaging device 100. For example, the image processing device 200 is connected to the polarization imaging device 100, and information cooperation is performed between the devices. The polarization imaging device 100 and the image processing device 200 are connected to an information communication network N by wireless or wired communication so as to mutually perform information/data communication and operate in cooperation. The information communication network N may include the Internet, a home network, an Internet of Things (IoT) network, a Peer-to-Peer (P2P) network, a proximity communication mesh network, and the like. In the wireless communication, for example, Wi-Fi, Bluetooth (registered trademark), or a technology based on a mobile communication standard such as a 4G or a 5G can be uses. In the wired communication, a power line communication technology such as Ethernet (registered trademark) or power line communications (PLC) can be used.

The polarization imaging device 100 and the image processing device 200 may be separately provided as a plurality of computer hardware devices on so-called on-premises, an edge server, or a cloud, or the functions of a plurality of devices of the polarization imaging device 100 and the image processing device 200 may be provided as the same device. For example, the polarization imaging device 100 and the image processing device 200 may be provided as a device in which the polarization imaging device 100 and the image processing device 200 function integrally and communicate with an external information processing device. Furthermore, the user can mutually perform information/data communication with the polarization imaging device 100 and the image processing device 200 via a user interface (including a graphical user interface: GUI) and software (composed of a computer program (hereinafter, also referred to as a program)) operating on a terminal device (not illustrated) (a personal computer (PC) including a display, a voice, and a keyboard input as an information display device or a personal device such as a smartphone).

### (1) Polarization Imaging Device 100

The polarization imaging device 100 is a polarization imaging device that enables generation of a captured image by reconstructing light. For example, the polarization imaging device 100 is an endoscope. The polarization imaging device 100 includes the image sensor 50 that detects light (for example, electromagnetic waves of light). For example, the polarization imaging device 100 includes the image sensor 50 that is a monochromatic (monochromatic) sensor. Furthermore, the polarization imaging device 100 includes the mask 10 (for example, the URA mask 10U) having a predetermined pattern superimposed on the image sensor 50.

The polarization imaging device 100 enables reconstruction of a captured image by capturing light using the mask 10 having a predetermined pattern of the light transmitting filter 12 and the light non-transmitting filter 14. Furthermore, the polarization imaging device 100 can capture desired light by setting a polarization filter to the light transmitting filter 12. Then, the polarization imaging device 100 enables reconstruction of a captured image based on desired light transmitted through the polarization filter.

### (2) Image Processing Device 200

The image processing device 200 is an information processing devices that performs image processing for reconstructing a captured image. Specifically, the image processing device 200 performs processing of generating a captured image of a scene by acquiring observation data based on light from the scene transmitted through the mask 10 (for example, the URA mask 10U) superimposed on the image sensor 50 and reconstructing the observation data. Furthermore, the image processing device 200 performs processing of generating a captured image of an actual scene by reconstructing a captured image of each divided region (sub-sensor region) of the sub-sensor based on polarization of light from the scene. As a result, the image processing device 200 can effectively reconstruct the captured image of the actual scene while suppressing deterioration in image quality.

The image processing device 200 also has a function of controlling the overall operation of the image processing system 1. For example, the image processing device 200 controls the overall operation of the image processing system 1 based on information linked between the devices. Specifically, the image processing device 200 performs processing of generating a captured image of an actual scene based on the information transmitted from the polarization imaging device 100.

The image processing device 200 is realized by a PC, a server, or the like. Note that the image processing device 200 is not limited to a PC, a server, or the like. For example, the image processing device 200 may be a computer hardware device such as a PC or a server in which a function as the image processing device 200 is mounted as an application.

### 2. Function of Image Processing System

The configuration of the image processing system 1 has been described above. Next, functions of the image processing system 1 will be described.

### 2.1. Overview

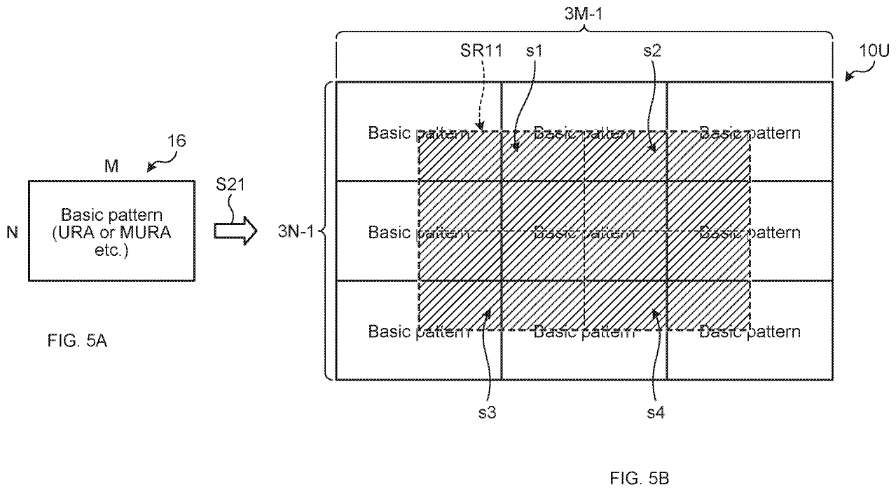

FIG. 5 is a diagram illustrating an outline of the image processing system 1 according to the embodiment, and is an explanatory diagram for explaining the present embodiment. (A) of FIG. 5 illustrates the basic pattern 16 constituting the URA mask 10U. The basic pattern 16 has a size of M×N pixels. (B) of FIG. 5 illustrates the URA mask 10U with (3M−1)×(3N−1) pixels generated by disposing the basic patterns 16 in 3 rows and 3 columns (step S21). Here, since the scanning lines of the last row and the last column in the pixel array of 3M×3N are not included, the pixel array of the URA mask 10U is (3M−1)×(3N−1). A region SR11 indicated by a dotted line in (B) of FIG. 5 indicates a sensor region.

The sensor region SR11 is located at the center of the URA mask 10U. Therefore, in the present embodiment, the captured image is generated based on the light incident on the URA mask 10U.

The sensor region SR11 is divided into sub-sensor regions s1 to s4 of an array (2×2 in this example) smaller by one than the array (3×3 in this example) of the basic pattern 16 in terms of the number of rows and columns. In the example illustrated in FIG. 5, the sensor region SR11 is divided into four sub-sensor regions s1 to s4. Each of the sub-sensor regions s1 to s4 is a region having the number of pixels equal to or larger than a predetermined threshold value. The center of each of the sub-sensor regions s1 to s4 may substantially coincide with a point where the corners of the four basic patterns 16 disposed in 2×2 of the URA mask 10U are concentrated.

By reconstructing observation data based on light incident on each of the sub-sensor regions s1 to s4, the captured images of the sub-sensor regions s1 to s4 can be generated. Hereinafter, the image processing system 1 according to the present embodiment will be described in detail using an embodiment of the image processing system 1 according to the embodiment.

In the following description, details of the image processing system 1 will be described using a method of setting three types of polarization filters (arrangement method). Specifically, a method of setting, based on a number assigned to each basic pattern 16, a predetermined polarization direction for the number (first example), a method of setting a different polarization direction for each block (area constituting the basic pattern 16) (second example), and a method of setting two polarization directions (third example) will be described.

### First Example

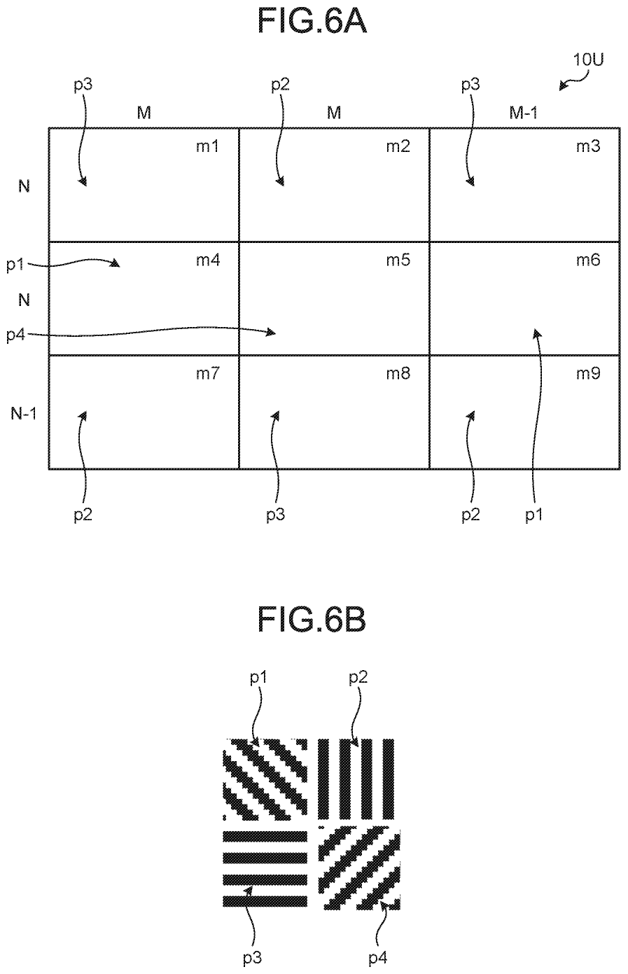

The first example will be described with reference to FIGS. 6 to 8. Note that, in FIGS. 6A and 6B, the URA mask 10U includes nine sub-mask regions (m1 to m9), and each sub-mask region has the basic pattern 16. FIG. 6A is a diagram illustrating an example of the URA mask 10U according to the first example. In the URA mask 10U illustrated in FIG. 6A, any of the mask patterns p1 to p4, which are polarization filters, is combined with the basic pattern 16 of each of the sub-mask regions m1 to m9. In FIG. 6A, the sensor region SR11 is omitted.

As illustrated in FIG. 6B, the mask patterns p1 to p4 have polarization directions with azimuth angles of 45 degrees, 0 degrees, 135 degrees, and 90 degrees from the horizontal direction (lateral direction in the plane of drawing) in this order. By using the four types of mask patterns p1 to p4, polarized components in all the four polarization directions can be acquired. Therefore, in the first example, the mask patterns p1 to p4 are combined with the sub-mask regions m1 to m9 such that all the four types of mask patterns p1 to p4 are superimposed on any four (2×2) basic patterns 16 among the nine basic patterns 16 constituting the URA mask 10U.

In FIG. 6A, for example, regarding the four upper left sub-mask regions m1, m2, m4, and m5 in the URA mask 10U, the mask pattern p3 with an azimuth angle of 0 degrees is combined with the sub-mask region m1, the mask pattern p2 with an azimuth angle of 90 degrees is combined with the sub-mask region m2, the mask pattern p1 with an azimuth angle of 135 degrees is combined with the sub-mask region m4, and the mask pattern p4 with an azimuth angle of 45 degrees is combined with the sub-mask region m5. The same applies to each of the other combinations (sub-mask regions (m2, m3, m5 and m6), sub-mask regions (m4, m5, m7 and m8), sub-mask regions (m5, m6, m8 and m9)) of the four basic patterns 16.

As described above, by combining all of the four types of mask patterns p1 to p4 with any four (2×2) basic patterns 16 of the URA mask 10U, it is possible to generate a non-polarized image (captured image) of each of the sub-sensor regions s1 to s4 from the observation data obtained in the sub-sensor regions s1 to s4 set to overlap the four basic patterns 16.

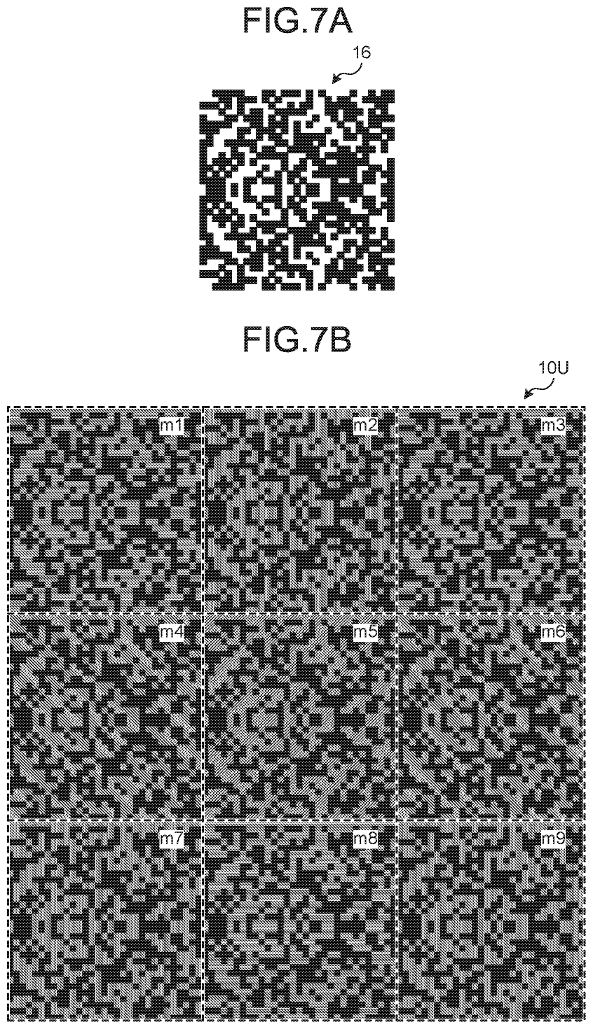

FIGS. 7A and 7B are diagrams illustrating specific examples of the URA mask 10U based on the mask pattern illustrated in FIG. 6B. FIG. 7A illustrates the basic pattern 16 having 33×31 pixels. FIG. 7B illustrates the URA mask 10U generated by disposing the basic patterns 16 in the horizontal and vertical directions. The mask pattern of the URA mask 10U illustrated in FIG. 7B corresponds to the mask pattern of FIG. 6B. Note that the URA mask 10U has 98×92 pixels, and the sensor region SR11 has 66×62 pixels.

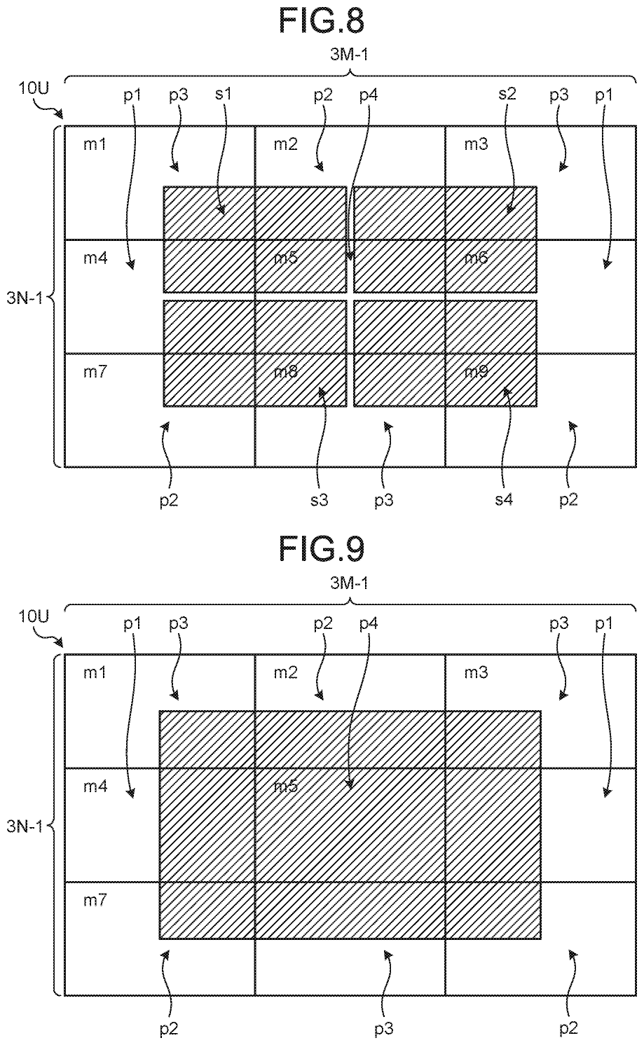

FIG. 8 is a diagram illustrating a positional relationship between the URA mask 10U illustrated in FIG. 6A and the sensor region SR11. As illustrated in FIG. 8, the mask patterns p1 to p4 are combined with the sub-mask regions m1 to m9 such that the mask patterns p1 to p4 in the four kinds of polarization directions are evenly included in the sub-sensor regions s1 to s4. In other words, the sensor region SR11 is set for the URA mask 10U such that each of the sub-sensor regions s1 to s4 evenly overlaps the four (2×2) basic patterns 16 with which the 4 types of mask patterns p1 to p4 are combined. In FIG. 8, for example, observation data based on light incident on the sub-sensor region s1 via the sub-mask regions m1, m2, m4, and m5 is reconstructed, so that a captured image of the sub-sensor region s1 is generated. Further, since the sub-sensor region s1 includes all the polarized component images corresponding to the mask patterns p1 to p4, it is also possible to reconstruct the original RGB image.

As described above, in the first example, by combining the mask patterns p1 to p4 having different polarization directions with the sub-mask regions m1 to m9, each of the sub-mask regions m1 to m9 functions as a polarization filter that selectively transmits a specific polarized component. Then, in the first example, in each of the sub-sensor regions s1 to s4, a polarized component image based on the polarized component transmitted through each of the mask patterns p1 to p4 is reconstructed. At this time, in the first example, since which area of the four areas (each area corresponds to any of the mask patterns p1 to p4) in each of the sub-sensor regions s1 to s4 detects which polarized component is associated in advance, not only the captured image based on each polarized component but also the captured image including all the polarized components, that is, the non-polarized image can be generated. For example, the non-polarized image can be generated by summing (for example, linear coupling) the captured images based on the respective polarized components.

Here, a method of calculating the non-polarized image will be described. When the incident light is uniformly randomly polarized light, linearly polarized light in one direction, or the like, the sum of a polarized component image whose polarization direction is an azimuth angle of 90 degrees (hereinafter, also referred to as longitudinally polarized light) and a polarized component image whose polarization direction is an azimuth angle of 0 degrees (hereinafter, also referred to as laterally polarized light) is equal to the sum of two polarized component images of a polarized component image having an azimuth angle of 135 degrees and a polarized component image having an azimuth angle of 45 degrees. In this case, when the sum of the polarized component image having an azimuth angle of 90 degrees and the polarized component image having an azimuth angle of 0 degrees and the sum of the polarized component image having an azimuth angle of 135 degrees and the polarized component image having an azimuth angle of 45 degrees each are I(unpolarized), the following Expression (1) is established. Note that I(unpolarized) is a captured image (non-polarized image) having no polarization.

I(unpolarized)=I(90)+I(0)=I(45)+I(135) (1)

In Expression, I(90) represents a polarized component image having an azimuth angle of 90 degrees, I(0) represents a polarized component image having an azimuth angle of 0 degrees, I(45) represents a polarized component image having an azimuth angle of 45 degrees, and I(135) represents a polarized component image having an azimuth angle of 135 degrees.

Here, the sub-sensor region s1 is set to overlap the sub-mask region m1, the sub-mask region m2, the sub-mask region m4, and the sub-mask region m5, the sub-sensor region s2 is set to overlap the sub-mask region m2, the sub-mask region m3, the sub-mask region m5, and the sub-mask region m6, the sub-sensor region s3 is set to overlap the sub-mask region m1, the sub-mask region m2, the sub-mask region m4, and the sub-mask region m5, and the sub-sensor region s4 is set to overlap the sub-mask region m5, the sub-mask region m6, the sub-mask region m8, and the sub-mask region m9.

Therefore, the captured image (non-polarized image) of each of the sub-sensor regions s1 to s4 can be expressed as the following Expression (2) based on the above Expression (1).

$$\begin{matrix}I ( m 1 + m 2 + m 4 + m 5 ) = I ( m 2 + m 3 + m 5 + m 6 ) \\ = I ( m 4 + m 5 + m 7 + m 8 ) \\ = I ( m 5 + m 6 + m 8 + m9 ) \\ = 2 * I ( unpolarized )\end{matrix} \qquad ( 2 )$$

In Expression (2), I(m1+m2+m4+m5) represents a captured image of the sub-sensor region s1. I(m2+m3+m5+m6) represents a captured image of the sub-sensor region s2. I(m4+m5+m7+m8) represents a captured image of the sub-sensor region s3. I(m5+m6+m8+m9) represents a captured image of the sub-sensor region s4.

As a method of generating the captured image of the entire sensor region SR11, there is a method of solving a matrix for each of the sub-sensor regions s1 to s4, but processing for this is necessary. Here, it can be derived that the image obtained by summing the captured images obtained in the respective sub-sensor regions s1 to s4 is equivalent to the image obtained by the sensor of M×N pixels covered with the mask of 2 rows and 2 columns (2 rows and 2 columns in combination unit, but 4 rows and 4 columns in basic pattern unit) constituted by four types of combinations (sub-mask regions (m1+m2+m4+m5), sub-mask regions (m2+m3+m5+m6), sub-mask regions (m4+m5+m7+m8), sub-mask regions (m5+m6+m8+m9)) of the four basic patterns 16 that each of the sub-sensor regions s1 to s4 overlaps. Therefore, in the first example, by adding the captured images of the sub-sensor regions s1 to s4, the processing can be reduced. The following Expression (3) indicates a calculation expression for summing the captured images of the sub-sensor regions s1 to s4.

su=s1+s2+s3+s4 (3)

In Expression (3), s1 to s4 represent captured images of the sub-sensor regions s1 to s4, respectively. su represents a captured image of the entire sensor region SR11. Note that each of s1 to s4 and su is a non-polarized image obtained by summing all polarized component images.

By applying the matrix structure illustrated in FIG. 8 to Expression (3), Expression (3) can be transformed into Expression (4) below, and a captured image (non-polarized image) of M×N pixels is obtained.

$$[ \begin{matrix}p 3 & p 2 \\ p 1 & p 4\end{matrix} ] + [ \begin{matrix}p 2 & p 3 \\ p 4 & p 1\end{matrix} ] + [ \text{} \begin{matrix}p 1 & 4 \\ p 2 & 3\end{matrix} ] + [ \begin{matrix}p 4 & p 1 \\ p 3 & p 2\end{matrix} ] = [ \begin{matrix}p 3 + p 2 + p 1 + p 4 & p 2 + p 3 + p 4 + p 1 \\ p 1 + p 4 + p 2 + p 3 & p 4 + p 1 + p 3 + p 2\end{matrix} ] \qquad ( 4 )$$

According to the above-described method, a non-polarized image of M×N pixels encoded by the binary mask 10 (URA mask 10U) of the basic pattern 16 can be generated by a simple method of summing the captured images obtained in the four sub-sensor regions s1 to s4. As a result, it is possible to realize a robust reconstruction method with high calculation efficiency.

However, in the above method, the polarization information cannot be extracted from the imaging scene. Therefore, in order to extract the polarization information about the imaging scene, it is necessary to use another reconstruction algorithm.

The above reconstruction problem can be expressed as, for example, a linear inverse problem as illustrated in FIG. 9. In the linear inverse problem, the detection value from the image sensor 50 is modeled by Expression (5).

$$Sensor value = {[ \begin{matrix}{A}_{0} \\ {A}_{1} \\ {A}_{2}\end{matrix} ]}^{T} [ \begin{matrix}{Xs}_{0} \\ {Xs}_{1} \\ {Xs}_{2}\end{matrix} ] \qquad ( 5 )$$

where “A1, A1, A2” denotes a matrix of coefficients generated based on the URA mask 10U. T denotes a transposed matrix. “Xs0, Xs1, Xs2” indicates a matrix of polarization information.

In order to solve Expression (5), there are various methods such as matrix inversion using a Tychonoff's normalization method. Then, the polarization information is obtained by solving Expression (5).

Note that the first example illustrates a case where the polarization filters of the mask patterns corresponding to the number of (“p3”, “p2”, “p3”, “p1”, “p4”, “p1”, “p2”, “p3”, and “p2”) are set in the order of the sub-mask region m1 to the sub-mask region m9. However, the present invention is not limited to this example, and any setting may be used as long as the number is imparted each of the sub-sensor regions s1 to s4 evenly overlaps the basic patterns 16 with the numbers of “p1” to “p4”. For example, the polarization filters of the mask patterns corresponding to (“p3”, “p2”, “p1”, “p1”, “p4”, “p3”, “p3”, “p2”, “p1”) or the polarization filter of the mask patterns corresponding to (“p3”, “p2”, “p3”, “p1”, “p4”, “p1”, “p3”, “p2”, and “p3”) may be set in the order of the sub-mask region m1 to the sub-mask region m9. Since 24 combinations with numbers “p1” to “p4” are possible, a total of 72 combinations of 3×24 polarization filters can be set.

The method of setting the predetermined polarization direction for each number (first example) is described above. Hereinafter, a method of setting a different polarization direction for each block (second example) will be described.

### Second Example

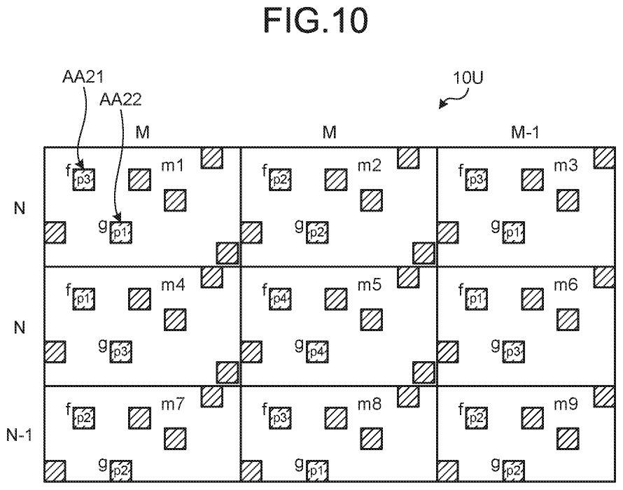

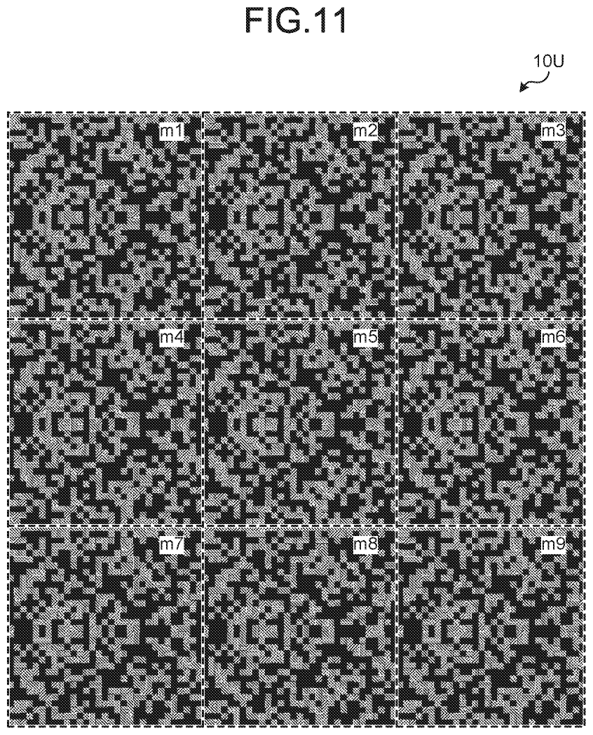

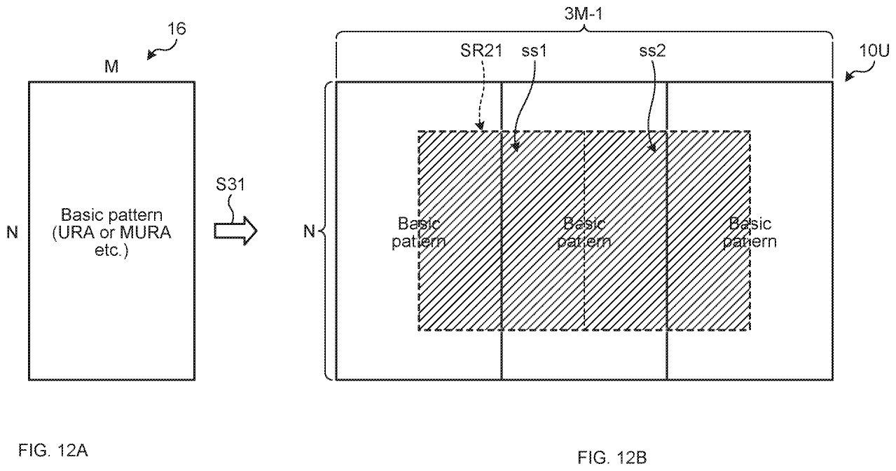

The second example will be described with reference to FIGS. 10 and 11. Note that the same description as in the first example will be omitted as appropriate. In FIG. 10, polarization filters in different directions are set for each block. In FIG. 10, directions different for each block are expressed by f and g. It is assumed that f(p1), f(p2), f(p3), f(p4), g(p1), g(p2), g(p3), and g(p4) indicate different directions. Note that f(p1) to f(p4) (the same applies to g(p1) to g(p4)) may be associated with any of the numbers of the mask pattern illustrated in FIG. 6. For example, the polarization filters of f(p3) and g(p1) are set for the area AA21 and the area AA22 in the sub-mask region m1, respectively. In this way, in FIG. 10, the URA mask 10U is configured using polarization directions indicated by f and g. As a result, more polarization filters can be set than in the case of the first example. Here, the actual URA mask 10U of FIG. 10 is illustrated in FIG. 11.

FIG. 11 illustrates an actual URA mask 10U based on the mask pattern of FIG. 10. The basic pattern 16 in FIG. 11 is similar to that in FIG. 7A. FIG. 11 illustrates the URA mask 10U generated by disposing the basic patterns 16 horizontally and vertically and applying the mask patterns. The mask patterns of the URA mask 10U in FIG. 11 correspond to the mask patterns in FIG. 10. The URA mask 10U has 98×92 pixels, and the sensor region SR11 has 66×62 pixels. FIG. 11 illustrates the URA mask 10U having a result different from that of FIG. 7B in which a single polarization filter is set for each basic pattern 16.

### Third Example

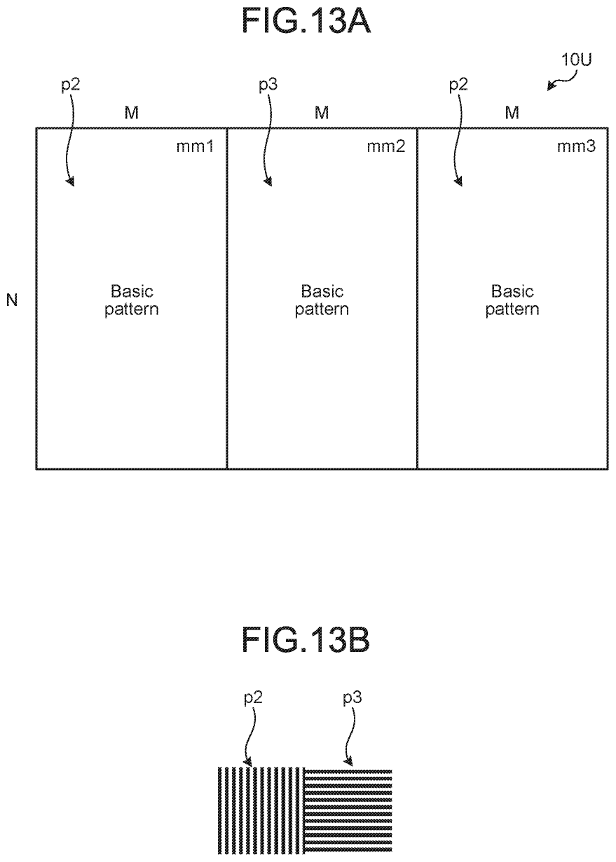

The third example will be described with reference to FIGS. 12 and 13. FIG. 12 is a diagram illustrating an outline of the third example, and is an explanatory diagram for explaining the third example. Note that the same description as in FIG. 5 will be appropriately omitted. (B) of FIG. 12 illustrates the URA mask 10U with (3M−1)×N pixels generated by disposing the basic patterns 16 in 3 rows and 1 column (step S31). Here, since the scanning line of the last column in the 3M×N pixel array is not included, the pixel array of the URA mask 10U is (3M−1)×N. A region SR21 indicated by a dotted line in (B) of FIG. 12 indicates a sensor region.

The sensor region SR21 is located at the center of the URA mask 10U. The sensor region SR21 is divided into sub-sensor regions ss1 to ss2.

In (B) of FIG. 12 and FIG. 13A, the URA mask 10U includes three sub-mask regions (mm1 to mm3), and each sub-mask region has the basic pattern 16. FIG. 13A is a diagram illustrating an example of the URA mask 10U according to the third example. In the URA mask 10U illustrated in FIG. 13A, one of the mask patterns p2 and p3 or one of p1 and p4, which are polarization filters, is combined with the basic pattern 16 of each sub-mask region mm1 to mm3. Here, a case where either p2 or p3 is combined will be described. In FIG. 13A, the sensor region SR21 is omitted.

As illustrated in FIG. 13B, the mask patterns p2 and p3 have polarization directions with azimuth angles of 0 degrees and 90 degrees from the horizontal direction. By using these two types of mask patterns p2 and p3, polarized components in two polarization directions can be acquired. Therefore, in the third example, the mask patterns p2 and p3 are combined with the sub-mask regions mm1 to mm3 such that two basic patterns of the three basic patterns 16 constituting the URA mask 10U are superimposed on all of the two types of mask patterns p2 and p3.

In FIG. 13A, for example, regarding the two mask patterns p2 and p3 in the URA mask 10U, the mask pattern p2 having an azimuth angle of 0 degrees is combined with the sub-mask regions mm1 and mm3, and the mask pattern p3 having an azimuth angle of 90 degrees is combined with the sub-mask region mm2.

As described above, by combining the two types of mask patterns p2 and p3 with any 2×1 basic pattern 16 of the URA mask 10U, it is possible to generate non-polarized light (captured image) of each of the sub-sensor regions ss1 and ss2 from the observation data obtained in the sub-sensor regions ss1 to ss2 set to overlap these two basic patterns 16.

Here, a method of calculating the non-polarized image will be described. In a case where the incident light is uniformly randomly polarized light, linearly polarized light in one direction, or the like, the sum of a polarized component image whose polarization direction is an azimuth angle of 90 degrees and a polarized component image whose polarization direction is an azimuth angle of 0 degrees satisfies Expression (1). Note that I(unpolarized) is a captured image (non-polarized image) having no polarization.

Here, the sub-sensor region ss1 is set to overlap the sub-mask regions mm1 and mm2, and the sub-sensor region ss2 is set to overlap the sub-mask regions mm2 and mm3.

Therefore, the captured image (non-polarized image) of each of the sub-sensor regions ss1 and ss2 can be expressed as the following Expression (6) based on the above Expression (1).

I(mm1+mm2)=I(mm2+mm1)=I(unpolarized) (6)

In Expression (6), I(mm1+mm2) represents a captured image of the sub-sensor region ss1, and I(mm2+mm1) represents a captured image of the sub-sensor region ss2.

As a method of generating the captured image of the entire sensor region SR11, there is a method of solving a matrix for each of the sub-sensor regions ss1 to ss4, but processing for this is necessary. Here, it can be derived that the image obtained by summing the captured images obtained in the respective sub-sensor regions ss1 to ss4 is equivalent to the image obtained by the sensor of M×N pixels covered with the mask of 2 rows and 2 columns (2 rows and 2 columns in combination unit, but 4 rows and 4 columns in basic pattern unit) constituted by four types of combinations (sub-mask regions (m1+m2+m4+m5), sub-mask regions (m2+m3+m5+m6), sub-mask regions (m4+m5+m7+m8), sub-mask regions (m5+m6+m8+m9)) of the four basic patterns 16 that each of the sub-sensor regions ss1 to ss4 overlaps. Therefore, in the first example, by adding the captured images of the sub-sensor regions ss1 to ss4, the processing can be reduced. The following Expression (7) indicates a calculation expression for summing the captured images of the sub-sensor regions ss1 and ss2.

suu=ss1+ss2 (7)

In Expression (7), ss1 and ss2 represent captured images of the sub-sensor regions ss1 and ss2, respectively. suu represents a captured image of the entire sensor region SR21. Note that each of ss1, ss2, and suu is a non-polarized image obtained by summing all polarized component images.

By applying the matrix structure illustrated in (B) of FIG. 12 to Expression (7), Expression (7) can be transformed into Expression (8) below, and a captured image (non-polarized image) of M×N pixels is obtained.

[p1p2]+[p2p1]=[p1+p2p2+p1] (8)

According to the above-described method, a non-polarized image of M×N pixels encoded by the binary mask 10 (URA mask 10U) of the basic pattern 16 can be generated by a simple method of summing the captured images obtained in the two sub-sensor regions ss1 to ss2. As a result, it is possible to realize a robust reconstruction method with high calculation efficiency.

However, in the above method, the polarization information cannot be extracted from the imaging scene. Therefore, in order to extract the polarization information about the imaging scene, it is possible to use the method for solving the linear inverse problem described in the first example (for example, Expression (5)).

The three types of polarization filter setting methods (arrangement methods) have been described above. Hereinafter, modifications of the URA mask 10U will be described.

### First Modification: Case Where Light Transmission Region is Sparse

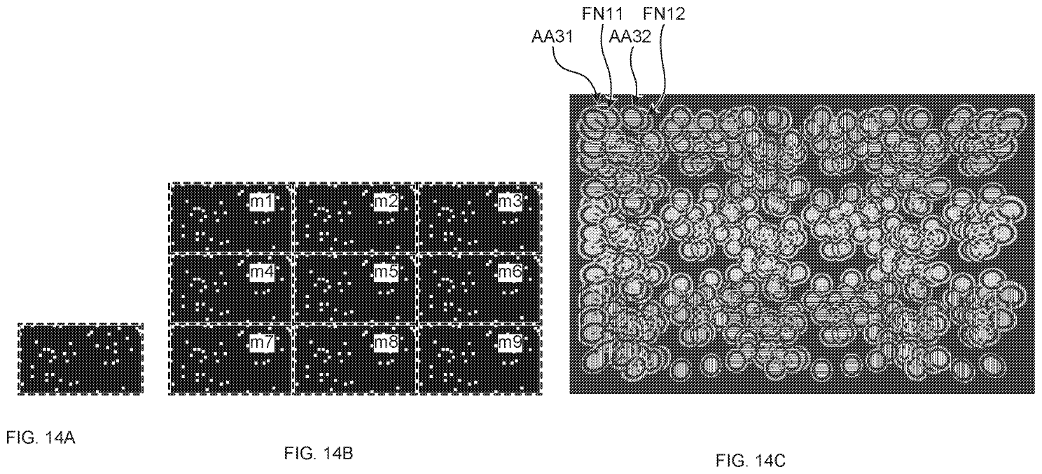

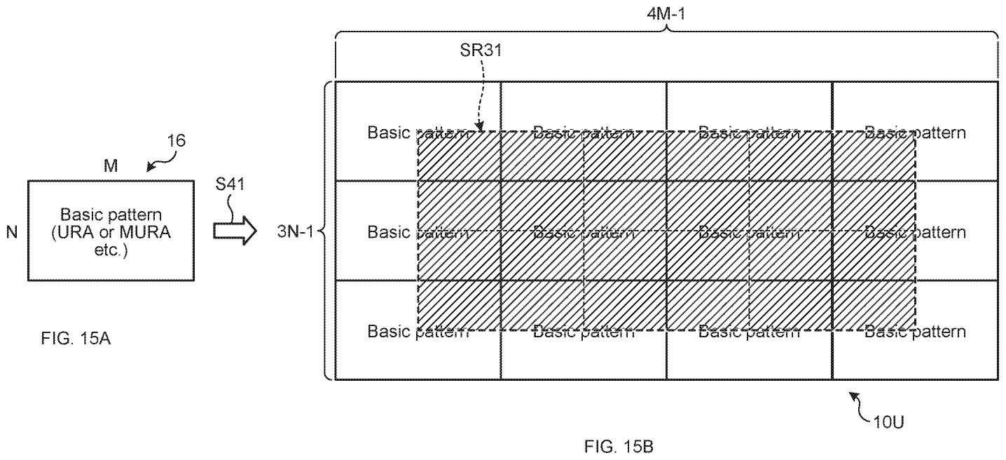

FIG. 14 is an explanatory diagram for explaining the URA mask 10U according to the first modification of the present embodiment. In FIG. 14, a large number of pinhole-shaped light transmission regions exist sparsely while maintaining a predetermined distance from each other. It is also possible to set a polarization filter for each pinhole-shaped light transmission region. Although it is also possible to enlarge the pinhole-shaped light transmission region, the image may be blurred when enlarged due to the nature of the shape of the pinhole, and thus the light transmission region is adjusted to a predetermined threshold value or less. By using this pinhole-shaped light transmission region, it is possible to improve the quality of the captured image such as improving noise.

(A) of FIG. 14 illustrates the basic pattern 16 having 61×37 pixels. (B) of FIG. 14 illustrates the URA mask 10U configured by disposing the 3×3 basic patterns 16. Then, FIG. 14C illustrates the URA mask 10U in a case where a Fresnel zone plate (FZP) is set for the light transmission region of the URA mask 10U. That is, the URA mask 10U has a predetermined pattern including a plurality of light transmitting filters disposed in a Fresnel pattern and a plurality of light non-transmitting filters. FIG. 14C illustrates, as an example, a case where the Fresnel zone plate FN11 and the Fresnel zone plate FN12 are set in an area AA31 and an area AA32. A Fresnel zone plate is a type of lens utilizing a diffraction phenomenon, and has characteristics similar to those of a pinhole. For example, Fresnel zone plate allows light to be focused at a predetermined position based on the pattern of the ring. The Fresnel zone plate can collect light more efficiently than pinhole. Unlike the case of the pinhole, the Fresnel zone plate is required to set the distance because the condensing depends on the distance. The URA mask 10U has 182×110 pixels, and a sensor region SR12 has 122×74 pixels.

### Second Modification: Case of Using Color Filter

Hereinafter, in the second example, a case where a reconstructed image is generated by setting color filters having different spectral patterns as light transmission regions will be described. In the second example, reconstructed images of different spectrums are generated based on light information obtained from the light transmission regions in which the color filters are set.

FIG. 15 corresponds to FIG. 5 of the first example. (B) of FIG. 15 illustrates the URA mask 10U with (4M−1)×(3N−1) pixels generated by disposing the basic patterns 16 illustrated in (A) of FIG. 15 (step S41). A region SR31 indicated by a dotted line in (B) of FIG. 15 indicates a sensor region. The sensor region SR31 is located at the center of the URA mask 10U, and a captured image is generated based on light dispersed by the URA mask 10U. In FIG. 15, the sensor region SR31 is divided into six regions so as to overlap the region of each basic pattern 16. The six divided regions indicate sub-sensor regions s1 to s6. In the second modification, the observation data based on the light dispersed with respect to each of the sub-sensor regions s1 to s6 is reconstructed to generate the captured image of each of the sub-sensor regions s1 to s6.

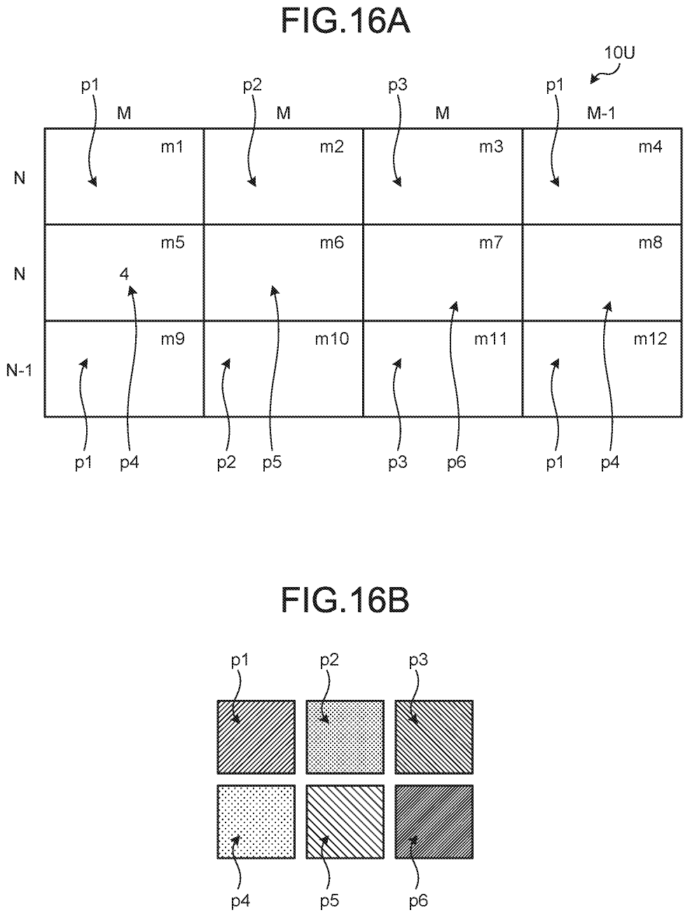

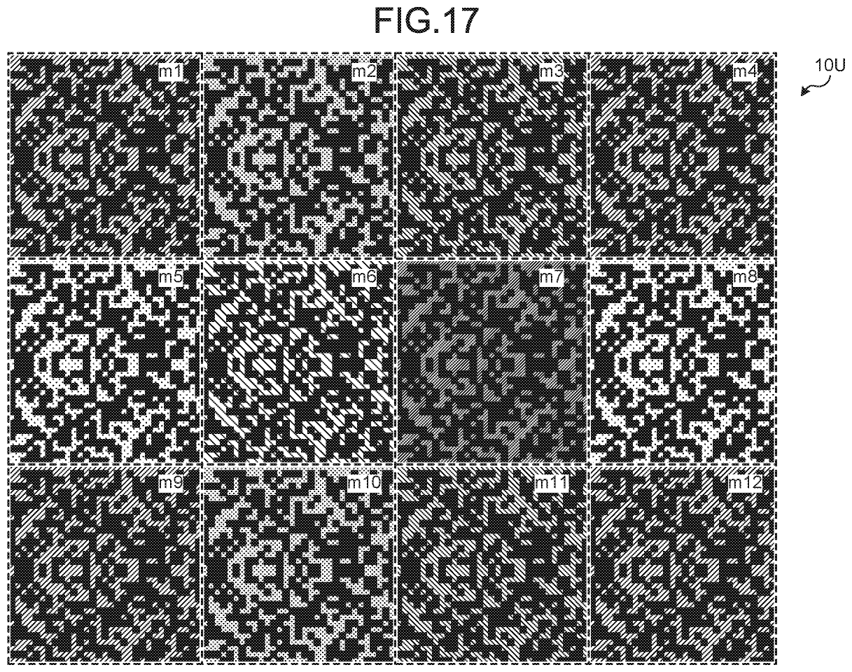

FIG. 16A is a diagram in which any one of numbers “p1” to “p6” is assigned to each basic pattern 16 of the URA mask 10U illustrated in (B) of FIG. 15. This number corresponds to a number for each of the six types of color filters illustrated in FIG. 16B. The filters numbered “p1” to “p6” are color filters of red, green, blue, yellow, brown, and purple in order. Through the six types of color filters, six types of different spectrums are possible. In FIG. 16A, for example, since the sub-mask region m1 is numbered “p1”, a red filter is set. In the region of the sub-mask region m1, the observation data based on the light dispersed by the red color filter is reconstructed. Here, the actual URA mask 10U of FIG. 16 is illustrated in FIG. 17. Note that the color of the filter is illustrated in the drawings for convenience.

FIG. 17 illustrates the actual URA mask 10U based on the color filters of FIG. 16. In FIG. 17, the basic pattern 16 similar to that in FIG. 7A is used. FIG. 17 illustrates the URA mask 10U generated by disposing the basic patterns 16 horizontally and vertically and applying color patterns. The URA mask 10U has 123×98 pixels, and the sensor region SR31 has 93×66 pixels.

### 2.2. Image Processing Device

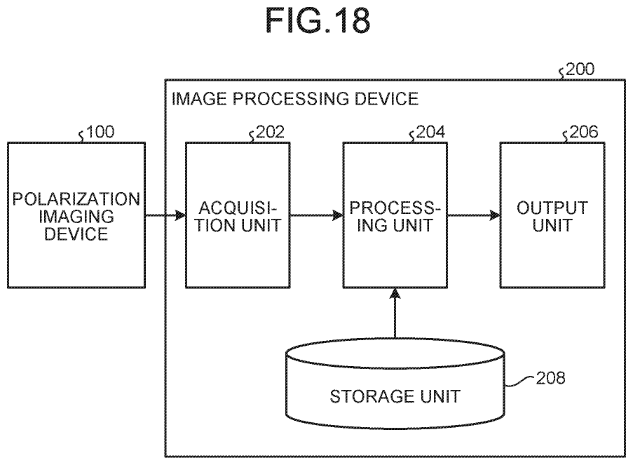

A detailed configuration of the image processing device 200 according to the present embodiment will be described with reference to FIG. 18. FIG. 18 is a block diagram illustrating an example of a function configuration of the image processing device 200 according to the present embodiment. As illustrated in FIG. 18, the image processing device 200 can mainly include an acquisition unit 202, a processing unit 204, an output unit 206, and a storage unit 208. Hereinafter, each functional block of the image processing device 200 will be sequentially described.

### (Acquisition Unit 202)

The acquisition unit 202 acquires the observation data (signal) output from the image sensor 50 of the polarization imaging device 100 to output the observation data (signal) to the processing unit 204 described later.

### (Processing Unit 204)

The processing unit 204 reconstructs the captured image of the desired scene based on the observation data (signal) from the acquisition unit 202 described above, the information about the predetermined pattern of the URA mask 10U stored in the storage unit 208 to be described later, and the information about the filter set in the light transmission portion of the URA mask 10U. Furthermore, the processing unit 204 outputs the captured image obtained by the reconstruction to the output unit 206 described later.

### (Output Unit 206)

The output unit 206 is a function unit for outputting a captured image to the user, and is realized by, for example, a display or the like.

### (Storage Unit 208)

The storage unit 208 stores programs, information, and the like for the above-described processing unit 204 to execute image processing, information obtained by the processing, and the like. Specifically, the storage unit 208 stores information such as a predetermined pattern of the URA mask 10U. Furthermore, the storage unit 208 may store information or the like of the filter set in the light transmission portion of the URA mask 10U. Note that the storage unit 208 is realized by, for example, a nonvolatile memory such as a flash memory.

### 2.3. Image Processing Method

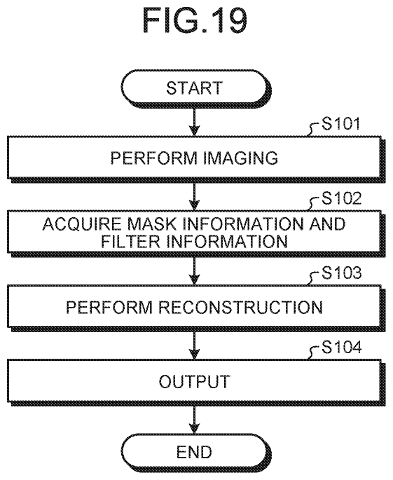

Next, an image processing method according to the present embodiment will be described with reference to FIG. 19. FIG. 19 is a flowchart of the image processing method according to the present embodiment. As illustrated in FIG. 19, the image processing method according to the present embodiment can mainly include steps from step 5101 to step 5104. Details of these steps according to the present embodiment will be described below.

First, a scene is captured by the above-described polarization imaging device 100 (step S101). Then, the image processing device 200 acquires, from the polarization imaging device 100, observation data (signal) generated by the image sensor 50 receiving the light transmitted through the URA mask 10U in which the filter is set in the light transmission portion.

Next, the image processing device 200 acquires mask information that is information about a predetermined pattern of the URA mask 10U and filter information set for the light transmission portion of the URA mask 10U (step S102). Specifically, the mask information is, for example, two-dimensional predetermined pattern information including the light transmitting filter 12 and the light non-transmitting filter 14 of the URA mask 10U. The filter information is, for example, setting information about a polarization filter, a color filter, and a Fresnel zone plate.

Next, the image processing device 200 calculates an inverse matrix (similar inverse matrix) based on the mask information and the filter information acquired in step 5102 described above. Then, the image processing device 200 reconstructs the captured image of the desired scene by multiplying the observation data acquired from the polarization imaging device 100 by the calculated inverse matrix (step S103).

Furthermore, the image processing device 200 outputs the captured image reconstructed in step 5103 described above to the user or the like (step S104), and ends the process.

### 2.4. Summary

As described above, according to the embodiment of the present disclosure described above, it is possible to provide the polarization imaging device 100, the binary mask 10 (for example, the URA mask 10U), the image processing device (image processing system 1) 200, and the image processing method that can be downsized while suppressing deterioration in image quality.

### 3. Hardware Configuration Example

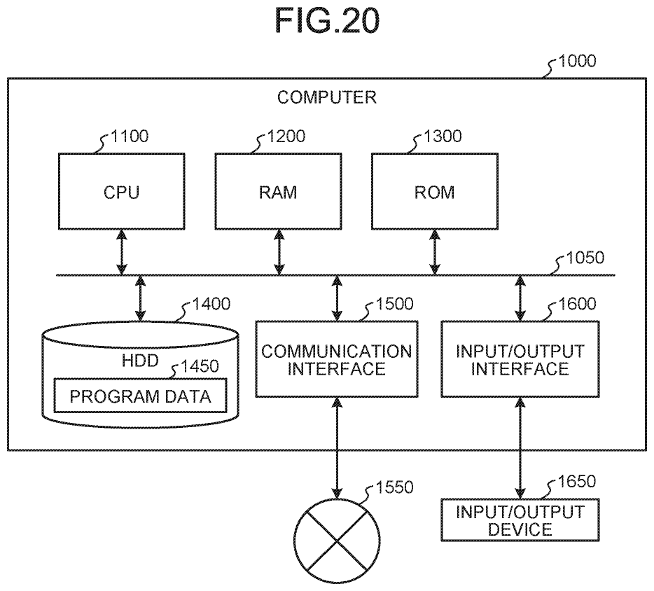

The image processing device 200 according to the embodiment of the present disclosure described above is realized by, for example, a computer 1000 having a configuration as illustrated in FIG. 20. Hereinafter, the image processing device 200 according to the embodiment of the present disclosure will be described as an example. FIG. 20 is a hardware configuration diagram illustrating an example of the computer 1000 that implements the functions of the image processing device 200. The computer 1000 includes a CPU 1100, a RAM 1200, a read only memory (ROM) 1300, a hard disk drive (HDD) 1400, a communication interface 1500, and an input/output interface 1600. Respective units of the computer 1000 are connected by a bus 1050.

The CPU 1100 operates based on a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records programs executed by the CPU 1100, data used by the programs, and the like. Specifically, the HDD 1400 is a recording medium that records an arithmetic processing program according to the present disclosure, which is an example of the program data 1450.

The communication interface 1500 is an interface for the computer 1000 to be connected to an external network 1550 (for example, the Internet). For example, the CPU 1100 receives data from another device or transmits data generated by the CPU 1100 to another device via the communication interface 1500.

The input/output interface 1600 is an interface that connects an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the image processing device 200 according to the embodiment of the present disclosure, the CPU 1100 of the computer 1000 executes the arithmetic processing program loaded on the RAM 1200 to implement the functions of the processing unit 204 (see FIG. 18) and the like. In addition, the HDD 1400 stores an image processing program and the like according to the embodiment of the present disclosure. The CPU 1100 reads the program data 1450 from the HDD 1400 and executes the program data, but as another example, the program may be acquired from another device via the external network 1550.

Furthermore, the image processing device 200 according to the present embodiment may be applied to a system including a plurality of devices on the premise of connection to a network (or communication between devices), such as cloud computing. That is, the image processing device 200 according to the present embodiment described above can also be implemented as an image processing system that performs image processing according to the present embodiment by a plurality of devices, for example.

### 4. Application Example to Endoscopic Surgery System

The technology according to the present disclosure (present technology) can be applied to various products. For example, the technology according to the present disclosure may be applied to an endoscopic surgery system.

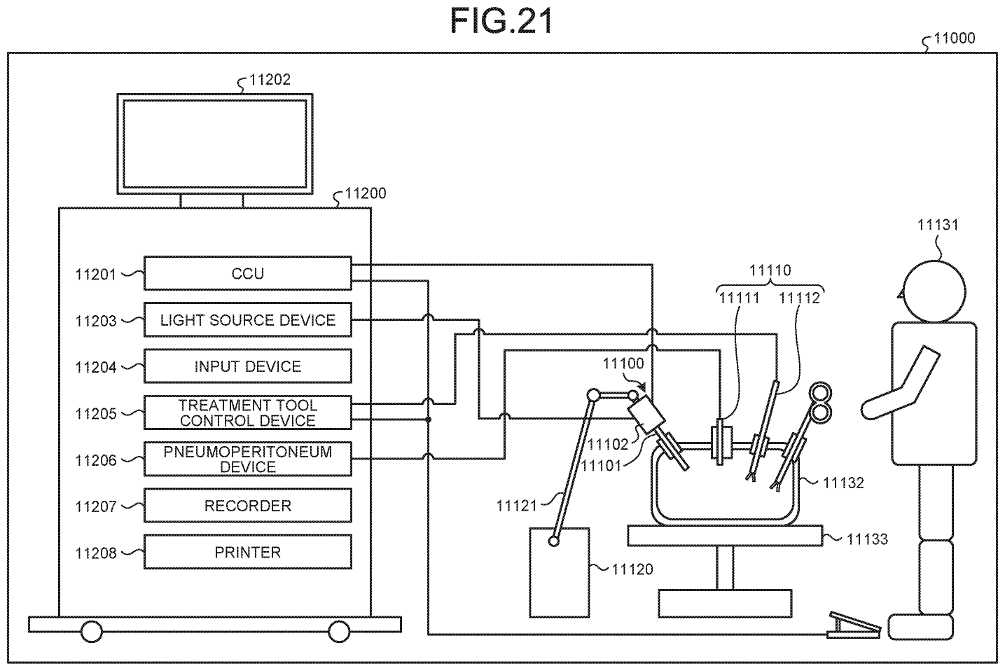

FIG. 21 is a diagram illustrating an example of a schematic configuration of an endoscopic surgery system to which the technology according to the present disclosure (the present technology) can be applied.

FIG. 21 illustrates a state in which an operator (doctor) 11131 is performing surgery on a patient 11132 on a patient bed 11133 using an endoscopic surgery system 11000. As illustrated, the endoscopic surgery system 11000 includes an endoscope 11100, other surgical tools 11110 such as a pneumoperitoneum tube 11111 and an energy treatment tool 11112, a support arm device 11120 that supports the endoscope 11100, and a cart 11200 on which various devices for endoscopic surgery are mounted.

The endoscope 11100 includes a lens barrel 11101 whose region of a predetermined length from the distal end is inserted into the body cavity of the patient 11132, and a camera head 11102 connected to the proximal end of the lens barrel 11101. In the illustrated example, the endoscope 11100 configured as a so-called rigid scope having the rigid lens barrel 11101 is illustrated, but the endoscope 11100 may be configured as a so-called flexible scope having a flexible lens barrel.

An opening portion into which an objective lens is fitted is provided at the distal end of the lens barrel 11101. A light source device 11203 is connected to the endoscope 11100, and light generated by the light source device 11203 is guided to the distal end of the lens barrel by a light guide extending inside the lens barrel 11101, and is emitted toward an observation target in the body cavity of the patient 11132 via the objective lens. Note that the endoscope 11100 may be a forward-viewing endoscope, an oblique-viewing endoscope, or a side-viewing endoscope.

An optical system and an imaging element are provided inside the camera head 11102, and reflected light (observation light) from the observation target is condensed on the imaging element by the optical system. The observation light is photoelectrically converted by the imaging element, and an electric signal corresponding to the observation light, that is, an image signal corresponding to the observation image is generated. The image signal is transmitted to a camera control unit (CCU) 11201 as RAW data.

The CCU 11201 includes a central processing unit (CPU), a graphics processing unit (GPU), and the like, and integrally controls the operation of the endoscope 11100 and a display device 11202. Furthermore, the CCU 11201 receives an image signal from the camera head 11102, and performs various types of image processing for displaying an image based on the image signal, such as development processing (demosaic processing), on the image signal.

The display device 11202 displays an image based on the image signal subjected to the image processing by the CCU 11201 under the control of the CCU 11201.

The light source device 11203 includes a light source such as a light emitting diode (LED), for example, and supplies irradiation light for photographing a surgical site or the like to the endoscope 11100.

An input device 11204 is an input interface for the endoscopic surgery system 11000. The user can input various types of information and instructions to the endoscopic surgery system 11000 via the input device 11204. For example, the user inputs an instruction or the like to change imaging conditions (type, magnification, focal length, and the like of irradiation light) by the endoscope 11100.

A treatment tool control device 11205 controls driving of the energy treatment tool 11112 for cauterization and incision of tissue, sealing of a blood vessel, or the like. A pneumoperitoneum device 11206 feeds gas into the body cavity of the patient 11132 via the pneumoperitoneum tube 11111 in order to inflate the body cavity for the purpose of securing a visual field by the endoscope 11100 and securing a working space of the operator. A recorder 11207 is a device capable of recording various types of information about surgery. A printer 11208 is a device capable of printing various types of information about surgery in various formats such as text, image, or graph.

Note that the light source device 11203 that supplies the endoscope 11100 with the irradiation light at the time of imaging the surgical site can include, for example, an LED, a laser light source, or a white light source including a combination thereof. In a case where the white light source includes a combination of RGB laser light sources, since the output intensity and the output timing of each color (each wavelength) can be controlled with high accuracy, adjustment of the white balance of the captured image can be performed in the light source device 11203. Furthermore, in this case, by irradiating the observation target with the laser light from each of the RGB laser light sources in a time division manner and controlling the driving of the imaging element of the camera head 11102 in synchronization with the irradiation timing, it is also possible to capture an image corresponding to each RGB in a time division manner. According to this method, a color image can be obtained without providing a color filter in the imaging element.

Furthermore, the driving of the light source device 11203 may be controlled so as to change the intensity of light to be output every predetermined time. By controlling the driving of the imaging element of the camera head 11102 in synchronization with the timing of the change in the light intensity to acquire images in a time division manner and synthesizing the images, it is possible to generate an image of a high dynamic range without so-called black crushing and bleaching.

Furthermore, the light source device 11203 may be configured to be able to supply light in a predetermined wavelength band corresponding to special light observation. In the special light observation, for example, so-called narrow band imaging is performed in which a predetermined tissue such as a blood vessel in a mucosal surface layer is imaged with high contrast by irradiating a body tissue with light in a narrower band than irradiation light (that is, white light) at the time of normal observation using wavelength dependency of light absorption in the body tissue. Alternatively, in the special light observation, fluorescence observation for obtaining an image by fluorescence generated by irradiation with excitation light may be performed. In the fluorescence observation, it is possible to irradiate a body tissue with excitation light to observe fluorescence from the body tissue (autofluorescence observation), or to locally inject a reagent such as indocyanine green (ICG) into a body tissue and irradiate the body tissue with excitation light corresponding to a fluorescence wavelength of the reagent to obtain a fluorescent image, for example. The light source device 11203 can be configured to be able to supply narrow band light and/or excitation light corresponding to such special light observation.

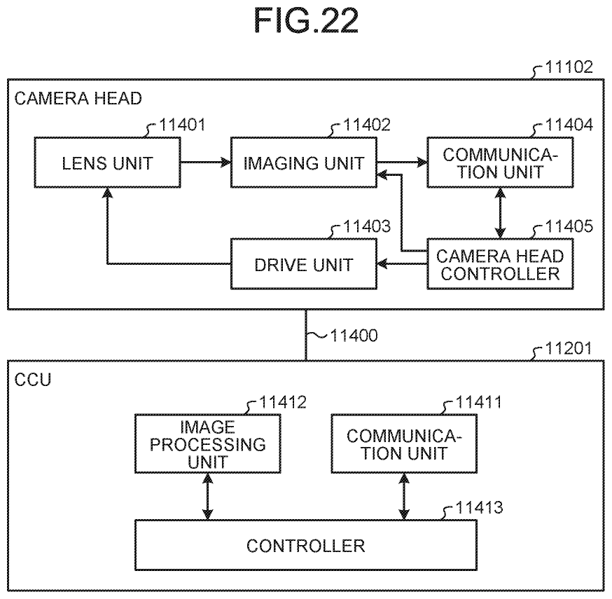

FIG. 22 is a block diagram illustrating an example of function configurations of the camera head 11102 and the CCU 11201 illustrated in FIG. 21.

The camera head 11102 includes a lens unit 11401, an imaging unit 11402, a drive unit 11403, a communication unit 11404, and a camera head controller 11405. The CCU 11201 includes a communication unit 11411, an image processing unit 11412, and a controller 11413. The camera head 11102 and the CCU 11201 are communicably connected to each other by a transmission cable 11400.

The lens unit 11401 is an optical system provided at a connection portion with the lens barrel 11101. Observation light taken in from the distal end of the lens barrel 11101 is guided to the camera head 11102 and enters the lens unit 11401. The lens unit 11401 is configured by combining a plurality of lenses including a zoom lens and a focus lens.

The number of imaging elements constituting the imaging unit 11402 may be one (so-called single-plate type) or plural (so-called multi-plate type). In a case where the imaging unit 11402 is configured as a multi-plate type, for example, image signals corresponding to RGB may be generated by the respective imaging elements, and a color image may be obtained by combining the image signals. Alternatively, the imaging unit 11402 may include a pair of imaging elements for acquiring right-eye and left-eye image signals corresponding to three-dimensional (3D) display. By performing the 3D display, the operator 11131 can more accurately grasp the depth of the living tissue in the surgical site. Note that, in a case where the imaging unit 11402 is configured as a multi-plate type, a plurality of lens units 11401 can be provided corresponding to the respective imaging elements.

Furthermore, the imaging unit 11402 may be not necessarily provided in the camera head 11102. For example, the imaging unit 11402 may be provided immediately after the objective lens inside the lens barrel 11101.

The drive unit 11403 includes an actuator, and moves the zoom lens and the focus lens of the lens unit 11401 by a predetermined distance along the optical axis under the control of the camera head controller 11405. As a result, the magnification and focus of the image captured by the imaging unit 11402 can be appropriately adjusted.

The communication unit 11404 includes a communication device for transmitting and receiving various types of information to and from the CCU 11201. The communication unit 11404 transmits the image signal obtained from the imaging unit 11402 as RAW data to the CCU 11201 via the transmission cable 11400.

Furthermore, the communication unit 11404 receives a control signal for controlling driving of the camera head 11102 from the CCU 11201, and supplies the control signal to the camera head controller 11405. The control signal includes, for example, information about imaging conditions such as information for specifying a frame rate of a captured image, information for specifying an exposure value at the time of imaging, and/or information for specifying a magnification and a focus of a captured image.

Note that the imaging conditions such as the frame rate, the exposure value, the magnification, and the focus may be appropriately specified by the user, or may be automatically set by the controller 11413 of the CCU 11201 based on the acquired image signal. In the latter case, a so-called auto exposure (AE) function, an auto focus (AF) function, and an auto white balance (AWB) function are installed in the endoscope 11100.

The camera head controller 11405 controls driving of the camera head 11102 based on the control signal from the CCU 11201 received via the communication unit 11404.

The communication unit 11411 includes a communication device for transmitting and receiving various types of information to and from the camera head 11102. The communication unit 11411 receives an image signal transmitted from the camera head 11102 via the transmission cable 11400.

Furthermore, the communication unit 11411 transmits a control signal for controlling driving of the camera head 11102 to the camera head 11102. The image signal and the control signal can be transmitted by electric communication, optical communication, or the like.

The image processing unit 11412 performs various types of image processing on the image signal that is RAW data transmitted from the camera head 11102.

The controller 11413 performs various types of control related to imaging of a surgical site or the like by the endoscope 11100 and display of a captured image obtained by imaging of the surgical site or the like. For example, the controller 11413 generates a control signal for controlling driving of the camera head 11102.

Furthermore, the controller 11413 causes the display device 11202 to display a captured image of a surgical site or the like based on the image signal subjected to the image processing by the image processing unit 11412. At this time, the controller 11413 may recognize various objects in the captured image using various image recognition techniques. For example, the controller 11413 can recognize a surgical tool such as forceps, a specific body part, bleeding, mist at the time of using the energy treatment tool 11112, and the like by detecting the shape, color, and the like of the edge of the object included in the captured image. When displaying the captured image on the display device 11202, the controller 11413 may superimpose and display various types of surgery support information on the image of the surgical site by using the recognition result. Since the surgery support information is superimposed and displayed and presented to the operator 11131, the burden on the operator 11131 can be reduced and the operator 11131 can reliably proceed with the surgery.

The transmission cable 11400 connecting the camera head 11102 and the CCU 11201 is an electric signal cable compatible with electric signal communication, an optical fiber compatible with optical communication, or a composite cable thereof.

Here, in the illustrated example, communication is performed by wire using the transmission cable 11400, but communication between the camera head 11102 and the CCU 11201 may be performed wirelessly.

An example of the endoscopic surgery system to which the technology according to the present disclosure can be applied is described above. The technology according to the present disclosure can be applied to the imaging unit 11402 and the like among the configurations described above.

Note that, here, the endoscopic surgery system is described as an example, but the technology according to the present disclosure may be applied to, for example, a microscopic surgery system or the like.

### 5. Application Example to Mobile Body

The technology according to the present disclosure (present technology) can be applied to various products. For example, the technology according to the present disclosure may be realized as a device mounted on any type of mobile body such as an automobile, an electric vehicle, a hybrid electric vehicle, a motorcycle, a bicycle, a personal mobility, an airplane, a drone, a ship, and a robot.

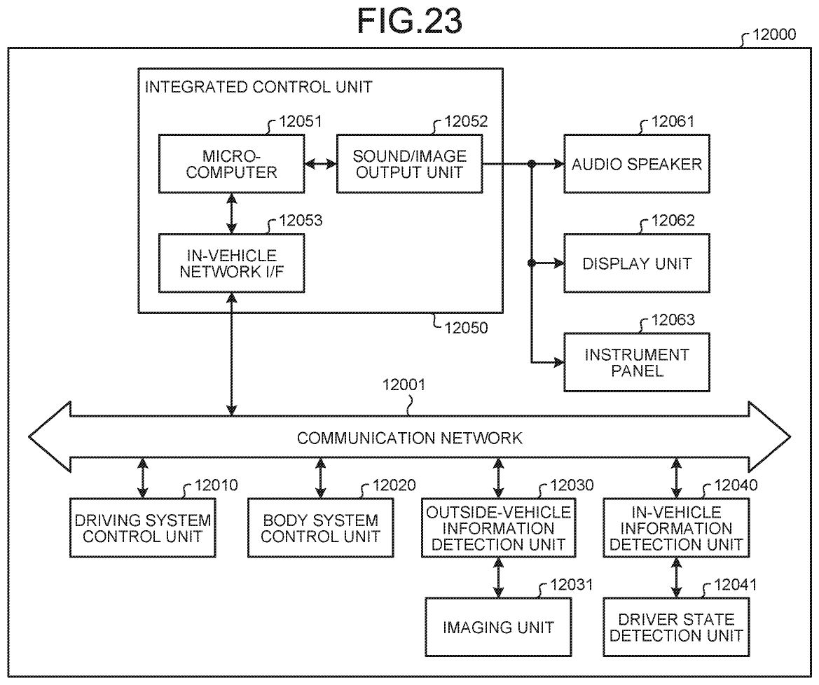

FIG. 23 is a block diagram illustrating a schematic configuration example of a vehicle control system which is an example of a mobile body control system to which the technology according to the present disclosure can be applied.

A vehicle control system 12000 includes a plurality of electronic control units connected via a communication network 12001. In the example illustrated in FIG. 23, the vehicle control system 12000 includes a driving system control unit 12010, a body system control unit 12020, an outside-vehicle information detection unit 12030, an in-vehicle information detection unit 12040, and an integrated control unit 12050. Furthermore, as a function configuration of the integrated control unit 12050, a microcomputer 12051, a sound/image output unit 12052, and an in-vehicle network interface (I/F) 12053 are illustrated.

The driving system control unit 12010 controls the operation of devices related to the drive system of the vehicle according to various programs. For example, the driving system control unit 12010 functions as a control device such as a driving force generation device that generates a driving force of the vehicle such as an internal combustion engine or a driving motor, a driving force transmitting mechanism for transmitting the driving force to wheels, a steering mechanism for adjusting a steering angle of the vehicle, a braking device that generates a braking force of the vehicle, and the like.

The body system control unit 12020 controls operations of various devices mounted on the vehicle body according to various programs. For example, the body system control unit 12020 functions as a control device of a keyless entry system, a smart key system, a power window device, or various lamps such as a head lamp, a back lamp, a brake lamp, a blinker, or a fog lamp. In this case, radio waves transmitted from a mobile device that substitutes for a key or signals of various switches can be input to the body system control unit 12020. The body system control unit 12020 receives input of these radio waves or signals, and controls a door lock device, a power window device, a lamp, and the like of the vehicle.

The outside-vehicle information detection unit 12030 detects information outside the vehicle on which the vehicle control system 12000 is mounted. For example, an imaging unit 12031 is connected to the outside-vehicle information detection unit 12030. The outside-vehicle information detection unit 12030 causes the imaging unit 12031 to capture an image of the outside of the vehicle, and receives the captured image. The outside-vehicle information detection unit 12030 may perform object detection processing or distance detection processing of a person, a vehicle, an obstacle, a sign, a character on a road surface, or the like based on the received image.

The imaging unit 12031 is an optical sensor that receives light to output an electric signal corresponding to the amount of received light. The imaging unit 12031 can output the electric signal as an image or can output the electric signal as distance measurement information. Furthermore, the light received by the imaging unit 12031 may be visible light or invisible light such as infrared rays.

The in-vehicle information detection unit 12040 detects information inside the vehicle. For example, a driver state detection unit 12041 that detects a state of a driver is connected to the in-vehicle information detection unit 12040.

The driver state detection unit 12041 includes, for example, a camera that images the driver, and the in-vehicle information detection unit 12040 may calculate the degree of fatigue or the degree of concentration of the driver or may determine whether the driver is dozing off based on the detection information input from the driver state detection unit 12041.

The microcomputer 12051 can calculate a control target value of the driving force generation device, the steering mechanism, or the braking device based on the information inside and outside the vehicle acquired by the outside-vehicle information detection unit 12030 or the in-vehicle information detection unit 12040 to output a control command to the driving system control unit 12010. For example, the microcomputer 12051 can perform cooperative control for the purpose of implementing functions of an advanced driver assistance system (ADAS) including collision avoidance or impact mitigation of the vehicle, follow-up traveling based on an inter-vehicle distance, vehicle speed maintenance traveling, vehicle collision warning, vehicle lane departure warning, or the like.

Furthermore, the microcomputer 12051 controls the driving force generation device, the steering mechanism, the braking device, or the like based on the information around the vehicle acquired by the outside-vehicle information detection unit 12030 or the in-vehicle information detection unit 12040, thereby performing cooperative control for the purpose of automatic driving or the like in which the vehicle autonomously travels without depending on the operation of the driver.

Furthermore, the microcomputer 12051 can output a control command to the body system control unit 12020 based on the vehicle exterior information acquired by the outside-vehicle information detection unit 12030. For example, the microcomputer 12051 can perform cooperative control for the purpose of preventing glare, such as switching from a high beam to a low beam, by controlling the head lamp according to the position of a preceding vehicle or an oncoming vehicle detected by the outside-vehicle information detection unit 12030.

The sound/image output unit 12052 transmits an output signal of at least one of a sound or an image to an output apparatus capable of visually or audibly notifying an occupant of the vehicle or the outside of the vehicle of information. In the example of FIG. 23, an audio speaker 12061, a display unit 12062, and an instrument panel 12063 are illustrated as the output apparatus. The display unit 12062 may include, for example, at least one of an on-board display and a head-up display.

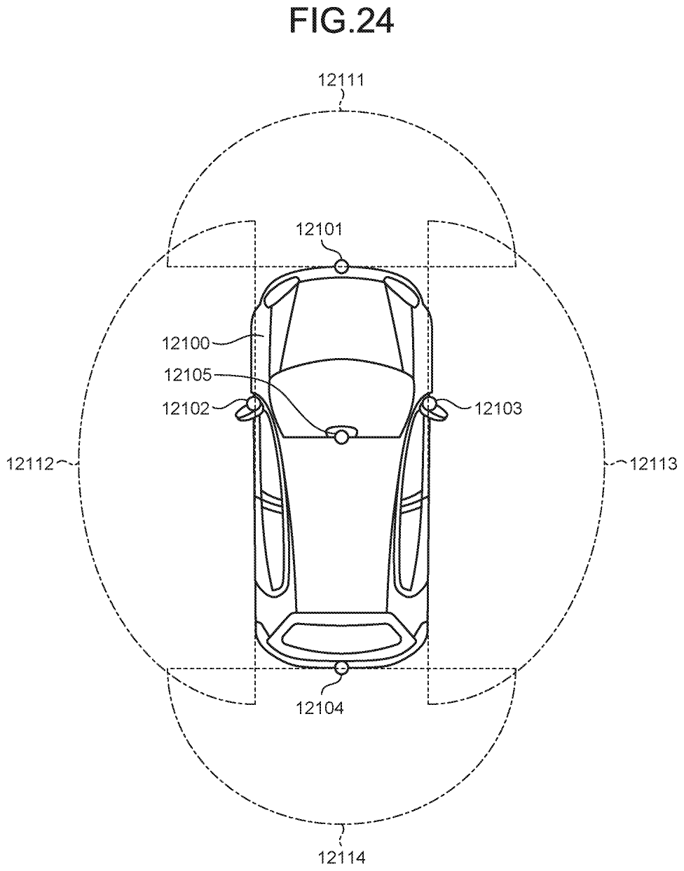

FIG. 24 is a diagram illustrating an example of an installation position of the imaging unit 12031.

In FIG. 24, imaging units 12101, 12102, 12103, 12104, and 12105 are included as the imaging unit 12031.

The imaging units 12101, 12102, 12103, 12104, and 12105 are provided, for example, at positions such as a front nose, a sideview mirror, a rear bumper, a back door, and an upper portion of a windshield in a vehicle interior of a vehicle 12100. The imaging unit 12101 provided at the front nose and the imaging unit 12105 provided at the upper portion of the windshield in the vehicle interior mainly acquire images in front of the vehicle 12100. The imaging units 12102 and 12103 provided at the sideview mirrors mainly acquire images sides of the vehicle 12100. The imaging unit 12104 provided at the rear bumper or the back door mainly acquires an image behind the vehicle 12100. The imaging unit 12105 provided at the upper portion of the windshield in the vehicle interior is mainly used to detect a preceding vehicle, a pedestrian, an obstacle, a traffic light, a traffic sign, a lane, or the like.

Note that FIG. 24 illustrates an example of imaging ranges of the imaging units 12101 to 12104. An imaging range 12111 indicates an imaging range of the imaging unit 12101 provided at the front nose, imaging ranges 12112 and 12113 indicate imaging ranges of the imaging units 12102 and 12103 provided at the sideview mirrors, respectively, and an imaging range 12114 indicates an imaging range of the imaging unit 12104 provided at the rear bumper or the back door. For example, by superimposing image data captured by the imaging units 12101 to 12104, a bird's-eye view image of the vehicle 12100 viewed from above is obtained.

At least one of the imaging units 12101 to 12104 may have a function of acquiring distance information. For example, at least one of the imaging units 12101 to 12104 may be a stereo camera including a plurality of imaging elements, or may be an imaging element having pixels for phase difference detection.

For example, the microcomputer 12051 obtains a distance to each three-dimensional object in the imaging ranges 12111 to 12114 and a temporal change in the distance (relative speed with respect to the vehicle 12100) based on the distance information obtained from the imaging units 12101 to 12104, thereby extracting, as a preceding vehicle, a three-dimensional object traveling at a predetermined speed (for example, 0 km/h or more) in substantially the same direction as the vehicle 12100, in particular, the closest three-dimensional object on a traveling path of the vehicle 12100. Furthermore, the microcomputer 12051 can set an inter-vehicle distance to be secured in advance in front of the preceding vehicle, and can perform automatic brake control (including follow-up stop control), automatic acceleration control (including follow-up start control), and the like. As described above, it is possible to perform cooperative control for the purpose of automatic driving or the like in which the vehicle autonomously travels without depending on the operation of the driver.

For example, based on the distance information obtained from the imaging units 12101 to 12104, the microcomputer 12051 can classify three-dimensional object data regarding three-dimensional objects into a two-wheeled vehicle, an ordinary vehicle, a large vehicle, a pedestrian, and another three-dimensional object such as a utility pole, extract the three-dimensional object data, and use the three-dimensional object data for automatic avoidance of an obstacle. For example, the microcomputer 12051 distinguish obstacles around the vehicle 12100 as an obstacle that can be visually recognized by the driver of the vehicle 12100 and an obstacle that are difficult to visually recognize. Then, the microcomputer 12051 determines a collision risk indicating a risk of collision with each obstacle, and when the collision risk is a setting value or more and there is a possibility of collision, the microcomputer can perform driving assistance for collision avoidance by outputting an alarm to the driver via the audio speaker 12061 or the display unit 12062 or performing forced deceleration or avoidance steering via the driving system control unit 12010.

At least one of the imaging units 12101 to 12104 may be an infrared camera that detects infrared rays. For example, the microcomputer 12051 can recognize a pedestrian by determining whether the pedestrian is present in the captured images of the imaging units 12101 to 12104. Such recognition of the pedestrian is performed by, for example, a procedure of extracting feature points in the captured images of the imaging units 12101 to 12104 as infrared cameras, and a procedure of performing pattern matching process on a series of feature points indicating an outline of an object to determine whether the object is a pedestrian. When the microcomputer 12051 determines that a pedestrian is present in the captured images of the imaging units 12101 to 12104 and recognizes the pedestrian, the sound/image output unit 12052 causes the display unit 12062 to superimpose and display a square contour line for emphasis for the recognized pedestrian. Furthermore, the sound/image output unit 12052 may causes the display unit 12062 to display an icon or the like indicating a pedestrian at a desired position.

An example of the vehicle control system to which the technology according to the present disclosure can be applied is described above. The technology according to the present disclosure can be applied to the imaging unit 12031 and the like among the configurations described above.

### 6. Supplement

Note that the embodiment of the present disclosure described above can include, for example, a program for causing a computer to function as the image processing device according to the present embodiment, and a non-transitory tangible medium on which the program is recorded. In addition, the program may be distributed via a communication line (including wireless communication) such as the Internet.

In addition, each step in the image prescription method of the embodiment of the present disclosure described above may not necessarily be processed in the described order. For example, each step may be processed in an appropriately changed order. In addition, each step may be partially processed in parallel or individually instead of being processed in time series. Furthermore, the processing method of each step may not necessarily be processed according to the described method, and may be processed by another method by another function unit, for example.

Although the preferred embodiments of the present disclosure have been described in detail with reference to the accompanying drawings, the technical scope of the present disclosure is not limited to such examples. It is obvious that a person having ordinary knowledge in the technical field of the present disclosure can conceive various changes or modifications within the scope of the technical idea described in the claims, and it is naturally understood that these also belong to the technical scope of the present disclosure.

Furthermore, the effects described in the present specification are merely illustrative or exemplary, and are not restrictive. That is, the technology according to the present disclosure can exhibit other effects obvious to those skilled in the art from the description of the present specification together with or instead of the above effects.

The present technology may also be configured as below.

(1)

A polarization imaging device including:
an image sensor having a first sub-sensor region, a second sub-sensor region, a third sub-sensor region, and a fourth sub-sensor region that are evenly divided and are adjacent to each other; and
a binary mask evenly superimposed on the first sub-sensor region, the second sub-sensor region, the third sub-sensor region, and the fourth sub-sensor region, the binary mask including a first sub-mask region having a first polarization direction, a second sub-mask region having a second polarization direction, a third sub-mask region having a third polarization direction, and a fourth sub-mask region having a fourth polarization direction, wherein
each of the first sub-mask region, the second sub-mask region, the third sub-mask region, and the fourth sub-mask region is disposed so as to be evenly superimposed on the first sub-sensor region, the second sub-sensor region, the third sub-sensor region, and the fourth sub-sensor region.
   (2)

The polarization imaging device according to (1), wherein the first to fourth polarization directions are different from each other by 45 degrees.

(3)

A polarization imaging device including:
an image sensor having a plurality of sub-sensor regions disposed in a distributed manner block by block; and
a binary mask that is superimposed on the plurality of sub-sensor regions and has a plurality of sub-mask regions having different polarization directions for the each block, wherein
each of the plurality of sub-mask regions is disposed to correspond to the plurality of sub-sensor regions.
   (4)

A polarization imaging device including:
an image sensor having a first sub-sensor region and a second sub-sensor region that are evenly divided and are adjacent to each other; and
a binary mask superimposed on the first sub-sensor region and the second sub-sensor region, the binary mask including a first sub-mask region having a first polarization direction, a second sub-mask region having a second polarization direction, and a third sub-mask region having the first polarization direction, wherein
the second sub-mask region is disposed so as to be evenly superimposed on the first sub-sensor region and the second sub-sensor region.
   (5)

The polarization imaging device according to any one of (1) to (4), further including: a processing unit that reconstructs an image of a scene based on light detected by the image sensor based on observation data obtained through the binary mask, basic pattern information about the binary mask, and polarization filter information about a light transmitting material constituting the binary mask.

(6)

The polarization imaging device according to (5), wherein the processing unit reconstructs an individual image with each polarization direction from the light obtained through the binary mask.

(7)

The polarization imaging device according to (5) or (6), wherein the processing unit causes, in the binary mask, a linear combination of captured images obtained by dividing a sensor region of the image sensor to match a captured image generated using a predetermined pattern including basic patterns that are a plurality of the light transmitting materials repeated while being periodically positionally displaced.

(8)

The polarization imaging device according to any one of (1) to (7), wherein the predetermined pattern of the binary mask is a pattern of a uniformly redundant arrays (URA) mask or a modified uniformly redundant arrays (MURA) mask.

(9)

The polarization imaging device according to (8), wherein the predetermined pattern is a pattern including a plurality of light transmitting materials and a plurality of light non-transmitting materials that are disposed in a two-dimensional lattice.

(10)

The polarization imaging device according to any one of (1) to (9), wherein the image sensor is a line sensor or an area sensor.

(11)

The polarization imaging device of (10), wherein the image sensor is a monochromatic sensor.

(12)

The polarization imaging device according any one of (1) to (11), wherein the predetermined pattern of the binary mask includes a plurality of types of color filters.

(13)

The polarization imaging device according any one of (1) to (12), including a plurality of the binary masks.

(14)

A binary mask evenly superimposed on an image sensor having a first sub-sensor region, a second sub-sensor region, a third sub-sensor region, and a fourth sub-sensor region that are evenly divided and are adjacent to each other, the binary mask including a first sub-mask region having a first polarization direction, a second sub-mask region having a second polarization direction, a third sub-mask region having a third polarization direction, and a fourth sub-mask region having a fourth polarization direction, wherein
each of the first sub-mask region, the second sub-mask region, the third sub-mask region, and the fourth sub-mask region is disposed so as to be evenly superimposed on the first sub-sensor region, the second sub-sensor region, the third sub-sensor region, and the fourth sub-sensor region.
   (15)

An image processing system including:
an acquisition unit that acquires observation data observed by an image sensor capable of detecting light from a scene, the observation data being based on light from the scene and having passed through a binary mask having a predetermined pattern disposed to be superimposed on the image sensor; and
a processing unit that generates a captured image of the scene by reconstructing the observation data, wherein
the predetermined pattern of the binary mask includes a light non-transmitting material and a light transmitting material including a plurality of types of polarization filters that selectively controls a polarization direction in which the light is transmits, and wherein
the binary mask includes a first sub-mask region having a first polarization direction, a second sub-mask region having a second polarization direction, a third sub-mask region having a third polarization direction, and a fourth sub-mask region having a fourth polarization direction.
   (16)

An image processing method including:
acquiring observation data observed by an image sensor capable of detecting light from a scene, the observation data being based on light from the scene and having passed through a binary mask having a predetermined pattern disposed to be superimposed on the image sensor; and
generating a captured image of the scene by reconstructing the observation data, wherein
the predetermined pattern of the binary mask includes a light non-transmitting material and a light transmitting material including a plurality of types of polarization filters that selectively controls a polarization direction in which the light is transmitted, and wherein
the binary mask includes a first sub-mask region having a first polarization direction, a second sub-mask region having a second polarization direction, a third sub-mask region having a third polarization direction, and a fourth sub-mask region having a fourth polarization direction.

### REFERENCE SIGNS LIST

1 IMAGE PROCESSING SYSTEM
10, 10B, 10U, 10MU BINARY MASK
12 LIGHT TRANSMITTING FILTER
14 LIGHT NON-TRANSMITTING FILTER
16 BASIC PATTERN
50 IMAGE SENSOR
52 PIXEL
100 POLARIZATION IMAGING DEVICE
200 IMAGE PROCESSING DEVICE
202 ACQUISITION UNIT
204 PROCESSING UNIT
206 OUTPUT UNIT
208 STORAGE UNIT

1. A polarization imaging device including:
an image sensor having a first sub-sensor region, a second sub-sensor region, a third sub-sensor region, and a fourth sub-sensor region that are evenly divided and are adjacent to each other; and
a binary mask evenly superimposed on the first sub-sensor region, the second sub-sensor region, the third sub-sensor region, and the fourth sub-sensor region, the binary mask including a first sub-mask region having a first polarization direction, a second sub-mask region having a second polarization direction, a third sub-mask region having a third polarization direction, and a fourth sub-mask region having a fourth polarization direction, wherein
each of the first sub-mask region, the second sub-mask region, the third sub-mask region, and the fourth sub-mask region is disposed so as to be evenly superimposed on the first sub-sensor region, the second sub-sensor region, the third sub-sensor region, and the fourth sub-sensor region.

2. The polarization imaging device according to claim 1, wherein the first to fourth polarization directions are different from each other by 45 degrees.

3. A polarization imaging device including:
an image sensor having a plurality of sub-sensor regions disposed in a distributed manner block by block; and
a binary mask that is superimposed on the plurality of sub-sensor regions and has a plurality of sub-mask regions having different polarization directions for the each block, wherein
each of the plurality of sub-mask regions is disposed to correspond to the plurality of sub-sensor regions.

4. A polarization imaging device including:
an image sensor having a first sub-sensor region and a second sub-sensor region that are evenly divided and are adjacent to each other; and
a binary mask superimposed on the first sub-sensor region and the second sub-sensor region, the binary mask including a first sub-mask region having a first polarization direction, a second sub-mask region having a second polarization direction, and a third sub-mask region having the first polarization direction, wherein
the second sub-mask region is disposed so as to be evenly superimposed on the first sub-sensor region and the second sub-sensor region.

5. The polarization imaging device according to claim 1, further including: a processing unit that reconstructs an image of a scene based on light detected by the image sensor based on observation data obtained through the binary mask, basic pattern information about the binary mask, and polarization filter information about a light transmitting material constituting the binary mask.

6. The polarization imaging device according to claim 5, wherein the processing unit reconstructs an individual image with each polarization direction from the light obtained through the binary mask.

7. The polarization imaging device according to claim 5, wherein the processing unit causes, in the binary mask, a linear combination of captured images obtained by dividing a sensor region of the image sensor to match a captured image generated using a predetermined pattern including basic patterns that are a plurality of the light transmitting materials repeated while being periodically positionally displaced.

8. The polarization imaging device according to claim 1, wherein the predetermined pattern of the binary mask is a pattern of a uniformly redundant arrays (URA) mask or a modified uniformly redundant arrays (MURA) mask.

9. The polarization imaging device according to claim 8, wherein the predetermined pattern is a pattern including a plurality of light transmitting materials and a plurality of light non-transmitting materials that are disposed in a two-dimensional lattice.

10. The polarization imaging device according to claim 1, wherein the image sensor is a line sensor or an area sensor.

11. The polarization imaging device of claim 10, wherein the image sensor is a monochromatic sensor.

12. The polarization imaging device according to claim 1, wherein the predetermined pattern of the binary mask includes a plurality of types of color filters.

13. The polarization imaging device according to claim 1, including a plurality of the binary masks.

14. A binary mask evenly superimposed on an image sensor having a first sub-sensor region, a second sub-sensor region, a third sub-sensor region, and a fourth sub-sensor region that are evenly divided and are adjacent to each other, the binary mask including a first sub-mask region having a first polarization direction, a second sub-mask region having a second polarization direction, a third sub-mask region having a third polarization direction, and a fourth sub-mask region having a fourth polarization direction, wherein
each of the first sub-mask region, the second sub-mask region, the third sub-mask region, and the fourth sub-mask region is disposed so as to be evenly superimposed on the first sub-sensor region, the second sub-sensor region, the third sub-sensor region, and the fourth sub-sensor region.

15. An image processing system including:
an acquisition unit that acquires observation data observed by an image sensor capable of detecting light from a scene, the observation data being based on light from the scene and having passed through a binary mask having a predetermined pattern disposed to be superimposed on the image sensor; and
a processing unit that generates a captured image of the scene by reconstructing the observation data, wherein
the predetermined pattern of the binary mask includes a light non-transmitting material and a light transmitting material including a plurality of types of polarization filters that selectively controls a polarization direction in which the light is transmits, and wherein
the binary mask includes a first sub-mask region having a first polarization direction, a second sub-mask region having a second polarization direction, a third sub-mask region having a third polarization direction, and a fourth sub-mask region having a fourth polarization direction.

16. An image processing method including:
acquiring observation data observed by an image sensor capable of detecting light from a scene, the observation data being based on light from the scene and having passed through a binary mask having a predetermined pattern disposed to be superimposed on the image sensor; and
generating a captured image of the scene by reconstructing the observation data, wherein
the predetermined pattern of the binary mask includes a light non-transmitting material and a light transmitting material including a plurality of types of polarization filters that selectively controls a polarization direction in which the light is transmitted, and wherein
the binary mask includes a first sub-mask region having a first polarization direction, a second sub-mask region having a second polarization direction, a third sub-mask region having a third polarization direction, and a fourth sub-mask region having a fourth polarization direction.
